(19) United States
(12) Patent Application Publication
(10) Pub. No.: US 2021/0209289 A1
(43) Pub. Date: Jul. 8, 2021

(54) METHOD AND APPARATUS FOR GENERATING CUSTOMIZED CONTENT BASED ON USER INTENT

(71) Applicant: SAMSUNG ELECTRONICS CO., LTD., Suwon-si (KR)

(72) Inventors: Barath Raj KANDUR RAJA, Bangalore (IN); Sumit KUMAR, Bangalore North (IN); Sanjana TRIPURAMALLU, Bengaluru (IN); Vibhav AGARWAL, Bengaluru (IN); Ankur AGARWAL, Dist - MahenderGarh (IN); Chinmay ANAND, Katihar (IN); Likhith AMARVAJ, Bangalore (IN); Shashank SRIRAM, Bengaluru (IN); Himanshu ARORA, Bengaluru (IN); Jayesh Rajkumar VACHHANI, Bangalore (IN); Kranti CHALAMALASETTI, Bengaluru (IN); Rishabh KHURANA, Bengaluru (IN); Dwaraka Bhamidipati SREEVATSA, Bangalore (IN); Raju Suresh DIXIT, Bangalore (IN)

(73) Assignee: SAMSUNG ELECTRONICS CO., LTD., Suwon-si (KR)

(21) Appl. No.: 17/143,674

(22) Filed: Jan. 7, 2021

(30) Foreign Application Priority Data
Jan. 7, 2020 (IN) 202041000734

(51) Int. Cl. G06F 40/109; G06F 40/279; G06F 40/106

(52) U.S. Cl. CPC G06F 40/109; G06F 40/106; G06F 40/279

(57) ABSTRACT

An apparatus and method for generating a customized content are provided. An apparatus for generating a customized content, may include: at least one memory configured to store one or more instructions; at least one processor configured to execute the one or more instructions to: (1) obtain an input from a user; (2) detect, from the input, at least one feature and modality of the input among a plurality of modalities comprising a text format, a sound format, a still image format, and a moving image format; (3) determine a mode of the customized content, from a plurality of modes, based on the at least one feature and the modality of the input, the plurality of modes including an image mode and a text mode; and (4) generate the customized content based on the determined mode, and a display configured to display the customized content.

### CROSS-REFERENCE TO RELATED APPLICATION

This application is based on and claims priority under 35 U.S.C. § 119 of an Indian patent application number 202041000734, filed on Jan. 7, 2020, in the Indian Patent Office, the disclosure of which is incorporated by reference herein in its entirety.

### BACKGROUND

### 1. Field

The present disclosure relates to generation of multimodal content in an application. More particularly, the disclosure relates to systems and methods for multimodal content generation within an application based on user input.

### 2. Description Of Related Art

With the widespread of internet and social networking platforms, the exchange of information over such platforms has increased. Since the information exchange is communicated via messages on such platforms, it is important that the intent embedded in the message should be conveyed properly to the recipient. Most of the platforms provide static content with user intervening contents such as emoticon, memes, Graphics Interchange Format (GIF) images, etc., which are non-customizable and may not be appropriate for a conversation. Hence, tools for traditional content generation are not able to convey the intent behind the message properly leading to sending more messages for the same context to explain the intent behind the message due to improper intent communication.

Further, there are customizable digital content creation tools available which are aided by supporting props such as Greeting Templates, Sticker templates. However, it is tedious to find right content and navigate through endless templates to generate desired content.

A related technology provides a dynamic content creation, modification and distribution from a single source of content in online and offline scenarios, so that a user may create a dynamic content from any network device based on user modifiable elements, modify and distribute multiple sizes and/or formats on different platforms.

Another related technology provides adaptable layouts for social feeds. In the related technology, an activity is generated based on the social network action to collect metadata associated with a shared content. The shared content and the metadata are then mapped to layout templates that are each generated for different display layout formats associated with different types of client devices. .

However, the foregoing related technologies do not provide methods and systems for generating a multimodal content within an application based on a user input.

### SUMMARY

Example embodiments address at least the above problems and/or disadvantages and other disadvantages not described above. Also, the example embodiments are not required to overcome the disadvantages described above, and may not overcome any of the problems described above.

In accordance with an aspect of the disclosure, there is provided a method of generating a customized content, including: obtaining an input from a user; detecting, from the input, at least one feature and a modality of the input among a plurality of modalities comprising a text format, a sound format, a still image format, and a moving image format; determining a mode of the customized content, from a plurality of modes, based on the at least one feature and the modality of the input, the plurality of modes including an image mode and a text mode; and generating the customized content based on the determined mode.

The detecting the at least feature and the modality of the input may include: detecting an emotion or an activity of the user based on texts recognized in the input; and categorizing the modality and the at least one feature based on the detected emotion of the user or the detected activity of the user.

The generating the customized content may include generating the customized content based on the determined mode and the detected emotion of the user.

The categorizing the modality and the at least one features may include categorizing the modality and the at least one feature further based on a learned model and a predefined model.

The method may further include: obtaining intent information based on texts extracted from the input, wherein the texts extracted from the input may include at least one verb or one adjective, and wherein the generating the customized content may include generating the customized content based on the extracted texts and the determined mode.

The method may include determining at least one of a font size, a font type, or a color of the texts, based on the intent information; and the generating the customized content may include generating the customized content based on the determined mode and the at least one of the font size, the font type, or the color of the texts.

The method may further include: obtaining intent information based on texts extracted from the input, and determining a layout of the customized content based on the intent information, wherein the generating the customized content may include generating the customized content based on the layout and the determined mode.

The method may further include: obtaining at least one of time information or location information from the input, and the generating the customized content may include generating the customized content based on the determined mode and the at least one of the time information or the location information.

The method may further include: determining that the customized content requires an intervention of the user; and in response to the intervention of the user, displaying a second customized content.

The input may be a voice signal, and the method may further include: converting the voice signal into texts; identifying words, each of which has a pitch and a volume that are greater than a predetermined pitch and a predetermined volume, from the texts converted from the voice signal; and determining text information based on the identified words, wherein the generating the customized content may include generating the customized content based on the text information and the determined mode.

The method may further include: obtaining intent information, which indicates an intention of the user, based on texts extracted from the input, wherein the input comprises a plurality of texts, wherein the generating the customized content may include generating the customized content based on the intent information.

In accordance with an aspect of the disclosure, there is provided an apparatus for generating a customized content, the apparatus including: at least one memory configured to store one or more instructions; at least one processor configured to execute the one or more instructions to: obtain an input from a user; detect, from the input, at least one feature and modality of the input among a plurality of modalities comprising a text format, a sound format, a still image format, and a moving image format; determine a mode of the customized content, from a plurality of modes, based on the at least one feature and the modality of the input, the plurality of modes including an image mode and a text mode; and generate the customized content based on the determined mode, and a display configured to display the customized content.

The at least one processor may be further configured to execute the one or more instructions to: detect an emotion or an activity of the user based on texts recognized in the input; and categorize the modality and the at least one feature based on the detected emotion of the user or the detected activity of the user.

The at least one processor may be further configured to execute the one or more instructions to: generate the customized content based on the determined mode and the detected emotion of the user.

The at least one processor may be further configured to execute the one or more instructions to: obtain intent information based on texts extracted from the input, the texts extracted from the input comprising at least one verb or one adjective, and generate the customized content based on the extracted texts and the determined mode.

The at least one processor may be further configured to execute the one or more instructions to: determine at least one of a font size, a font type, or a color of the texts based on the intent information, and generate the customized content based on the determined mode and the at least one of the font size, the font type, or the color of the texts.

The at least one processor may be further configured to execute the one or more instructions to: obtain intent information based on texts extracted from the input; determine a layout of the customized content based on the intent information; and generate the customized content based on the layout and the determined mode.

The at least one processor may be further configured to execute the one or more instructions to: obtain at least one of time information or location information from the input, and generate the customized content based on the determined mode and the at least one of the time information or the location information.

The at least one processor may be further configured to execute the one or more instructions to: determine that the customized content requires an intervention of the user; and in response to the intervention of the user, control the display to display a second customized content.

In accordance with an aspect of the disclosure, there is provided a non-transitory computer readable storage medium having a computer readable instructions stored therein, when executed by at least one processor, configured to execute the computer readable instructions to cause the at least one processor to: obtain an input from a user; detect, from the input, at least one feature and modality of the input among a plurality of modalities comprising a text format, a sound format, a still image format, and a moving image format; determine a mode of a customized content, from a plurality of modes, based on the at least one feature and the modality of the input, the plurality of modes including an image mode and a text mode; and generate the customized content based on the determined mode.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an environment depicting an electronic device in communication with other electronic devices, according to an embodiment of the disclosure;

FIG. 2 illustrates a schematic view of the electronic device for multimodal content generation based on user input, according to an embodiment of the disclosure;

FIG. 3 illustrates a schematic block diagram of an electronic device, according to an embodiment of the disclosure;

FIG. 4A and FIG. 4B illustrate detecting modality information and features from the input of the user, according to an embodiment of the disclosure;

FIG. 4C illustrates a list of features from the input according to an embodiment of the disclosure

FIG. 4D, FIG. 4E, and FIG. 4F illustrate generating customized content, according to an embodiment of the disclosure;

FIG. 5 illustrates a process of identifying intent from the input and beautifying customized content according to an embodiment of the disclosure;

FIG. 6 illustrates retrieving information to generate customized content according to an embodiment of the disclosure;

FIG. 7 illustrates a process of generating customized content according to an embodiment of the disclosure;

FIG. 8 illustrates a process of generating customized content according to another embodiment of the disclosure;

FIG. 9A illustrates the structural module 218 according to an embodiment of the disclosure;

FIG. 9B illustrates an exemplary operation performed by the structural module 218 in the electronic device according to an embodiment of the disclosure;

FIG. 9C illustrates cluster of data formed by the structural module 218 to obtain a semi-structured data as output according to an embodiment of the disclosure;

FIG. 9D illustrates structural engine positioning objects based on the information received from the information module 214 according to an embodiment of the disclosure;

FIG. 10A illustrates a flowchart for multimodal content generation, according to an embodiment of the present disclosure;

FIG. 10B illustrates a flowchart for multimodal content generation based on a user input, according to an embodiment of the disclosure;

FIG. 11, FIG. 12, FIG. 13, FIG. 14, FIG. 15, FIG. 16, FIG. 17, FIG. 18, FIG. 19, and FIG. 20 illustrate an example of generating multimodal content by the electronic device according to embodiments of the disclosure;

FIG. 21A and FIG. 21B illustrate an exemplary operation performed by the electronic device 100 to compose a message according to an embodiment of the disclosure;

FIG. 22A and FIG. 22B illustrate an exemplary operation performed by the electronic device 100 to compose a message with context according to an embodiment of the disclosure;

FIG. 23A and FIG. 23B illustrate an exemplary operation performed by the electronic device according to an embodiment of the disclosure; and

FIG. 24 illustrates a process of generating multimodal content as customized content according to an embodiment of the disclosure.

### DETAILED DESCRIPTION

Various embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the embodiments can be practiced without those specifically defined matters. Also, well-known functions or constructions are not described in detail since they would obscure the description with unnecessary detail.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the terms “1st” or “first” and “2nd” or “second” may use corresponding components regardless of importance or order and are used to distinguish one component from another without limiting the components.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

Embodiments of the present disclosure will be described below in detail with reference to the accompanying drawings.

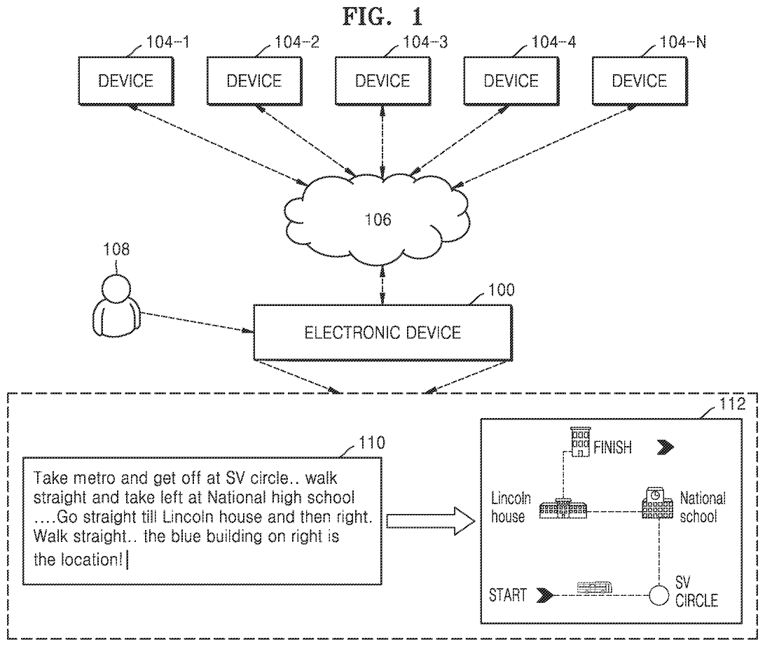

FIG. 1 illustrates an environment 106 depicting an electronic device 100 in communication with further devices 104-1, 104-2, 104-3, 104-4, . . . , 104-n interacting with the electronic device 100, according to an embodiment of the disclosure.

In an embodiment, the further devices 104-1, 104-2, 104-3, 104-4, . . . , 104-n may interchangeably be referred to as devices 104-1, 104-2, 104-3, 104-4, . . . , 104-n. The further devices 104-1, 104-2, 104-3, 104-4, . . . , 104-n may collectively be referred to as the devices 104, without departing from the scope of the disclosure. In an embodiment, the devices 104 may individually be referred to as the device 104, without departing from the scope of the present disclosure.

In an embodiment, the devices 104 may include but are not limited to, physical devices, vehicles, home appliances, and any other electronic item that can be connected to the network 106. For example, with respect to the home appliances, the devices 104 may include, but are not limited to, an Air Conditioner (AC), a refrigerator, a sound system, a television, a cellular device, a communication device, a microwave oven, an ambient light, a voice assistance device, interchangeably referred to as the voice assistance.

The electronic device 100 may interact with the devices 104 through a network 106. The network 106 may be a wired network or a wireless network. The network 106 may include, but is not limited to, a mobile network, a broadband network, a Wide Area Network (WAN), a Local Area Network (LAN), and a Personal Area Network.

In an embodiment, the electronic device 100 may be embodied as a smartphone, without departing from the scope of the present disclosure. In an embodiment, the electronic device 100 may be configured to generate multimodal content 112 within an application based on user input 110.

In an embodiment, the user 108 may enter an input 110 within an application on the electronic device 100. The electronic device 100 may recognize the input 110 to generate multimodal content as an output 112 within the application.

In an embodiment, the input 110 may be multimodal input such as text, voice, image, videos, GIF, Augmented Reality input, Virtual Reality input, Extended Reality input or any other mode of input. The input 110 is inputted by the user 108 within the application on the electronic device 100. The electronic device 100 may detect modality information and plurality of features from the input 110, and may identify intent of the input 108 based on the detected modality information and the detected plurality of features. The modality information may also be referred to as modality throughout the present disclosure. The electronic device 100 retrieves information for multimodal customized content generation and generates the multimodal customized content 112 based on the detected modality information, the detected plurality of features and the retrieved information. The electronic device 100 renders at least one multimodal customized content 112 to the user 108 within the application on the electronic device 100 for further action. Throughout the specification, the term of “multimodal customized content may be used interchangeably with the terms of “multimodal content” or “customized content”.

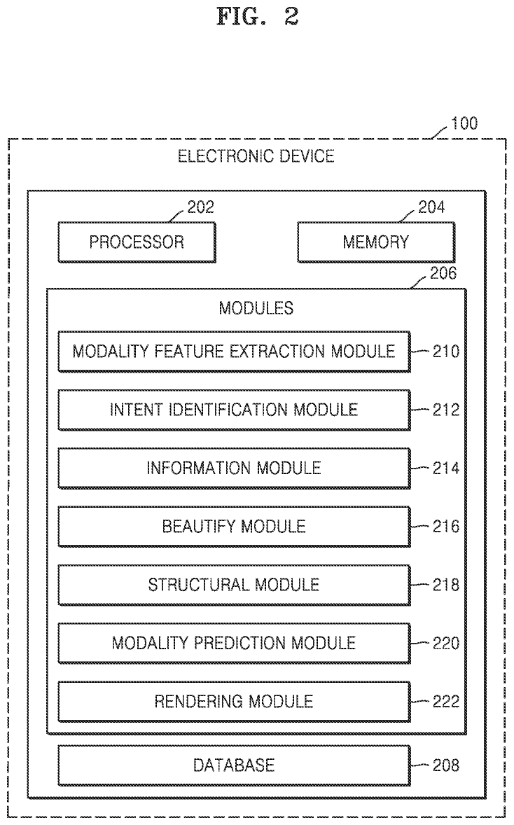

Constructional and operational details of the electronic device 100 are explained in detail referring to FIG. 2.

FIG. 2 illustrates a schematic view of the electronic device 100 to generate multimodal content as an output 112 according to an embodiment of the disclosure.

In an embodiment, the electronic device 100 may be implemented to generate a multimodal content as an output 112 within the application. In another embodiment, the electronic device 100 may be implemented using the information from one of the devices 104 to generate the multimodal content as an output 112. For instance, the electronic device 100 may include a processor 202 which obtains an input 110 from a user 108 in an application. The processor 202 may detect at least one modality and a plurality of features from the input 110 and identify intent of the user from the input 110 based on the detected modality and the detected plurality of features. In order to detect the modality and the plurality of features from the input 110, the processor 202 may detect emotion of the user 108, recognize activity of the user 108 and/or categorize the modality and the plurality of features based on the detected emotion, recognized activity, learned model and a predefined model. The processor 202 may retrieve information for multimodal content generation and generate the multimodal content based on the detected modality, the detected plurality of features and the retrieved information. In order to retrieve the information, the processor 202 may obtain the intent of the user from the input 110, extract at least one keyword from the intent of the user from input 110 and search a database of a user device 100 and other connected devices 104 for the information based on the at least one keyword. The processor 202 may render the generated multimodal content 112 to the user 108. Constructional and operational details of the electronic device 100 are explained in detail in later sections of the present disclosure.

In an embodiment, the electronic device 100 may include the processor 202, memory 204, module(s) 206, and database 208. The module(s) 206 and the memory 204 are connected to the processor 202. The processor 202 may be implemented as a single processing unit or a number of computer processing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions and data stored in the memory 204.

The memory 204 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The module(s) 206, among other things, include routines, programs, objects, components, data structures, etc., which perform particular tasks or implement data types. The module(s) 206 may also be implemented as signal processor(s), state machine(s), logic circuitries, and/or any other device or component that manipulate signals based on operational instructions.

Further, the module(s) 206 may be implemented in hardware, instructions executed by at least one processing unit, e.g., the processor 202. The processing unit may include a processor, a state machine, a logic array and/or any other suitable devices capable of processing instructions. The processing unit may be a general-purpose processor which executes instructions to cause the general-purpose processor to perform operations or, the processing unit may be dedicated to performing the required functions. In some example embodiments, the module(s) 206 may be machine-readable instructions (software, such as web-application, mobile application, program, etc.) which, when executed by a processor/processing unit, perform any of the described functionalities.

In an implementation, the module(s) 206 may include a modality feature extraction module 210, an intent identification module 212, an information module 214, a beautify module 216, a structural module 218, a modality prediction module 220 and a rendering module 222. The modality feature extraction module 210, the intent identification module 212, the information module 214, the beautify module 216, the structural module 218, the modality prediction module 220 and the rendering module 222 are in communication with each other. The database 208 serves, among other things, as a repository for storing data processed, received, and generated by one or more of the modules 206.

In an embodiment of the present disclosure, the module(s) 206 may be implemented as a part of the processor 202. In another embodiment of the disclosure, the module(s) 206 may be external to the processor 202. In yet another embodiment of the disclosure, the module(s) 206 may be a part of the memory 204. In another embodiment of the present disclosure, the module(s) 206 may be a part of hardware, separate from the processor 202.

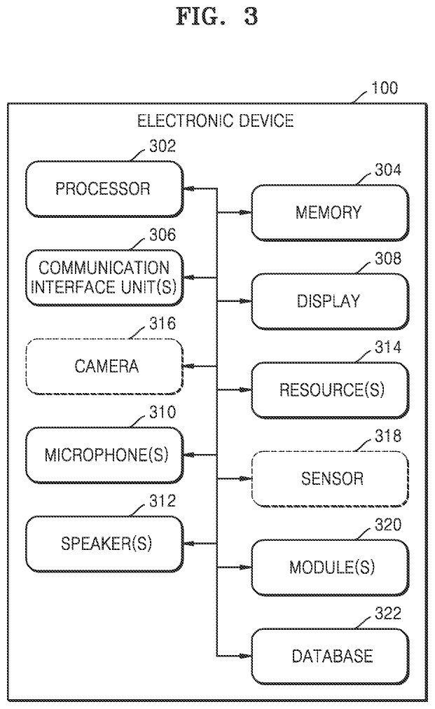

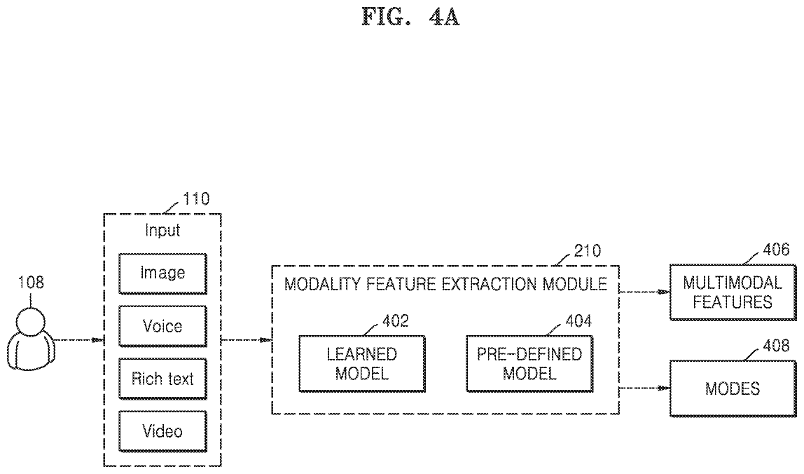

FIG. 3 illustrates a block diagram of the electronic device 100 according to an embodiment of the disclosure.

The electronic device may generate multimodal content as output 112 within the application on the electronic device 100. For the sake of brevity, features of the disclosure explained in detail in the description referring to FIG. 1 and FIG. 2 are not explained in detail in the description referring to FIG. 3 and therefore, the description referring to FIG. 3 should be read in conjunction with the description referring to FIG. 1 and FIG. 2 for better understanding.

The electronic device 100 may include at least one processor 302 (also referred to herein as “the processor 302”), a memory 304, a communication interface unit(s) 306, display 308, a microphones(s) 310, speaker(s) 312, a resource(s) 314, a camera 316, a sensor 318, a module(s) 320, and/or database 322. The processor 302, the memory 304, the communication interface unit(s) 306, the display 308, the microphones(s) 310, the speaker(s) 312, the resource(s) 314, the camera 316, the sensor 318, and/or the module(s) 320 may be communicatively coupled with each other via a bus (illustrated using directional arrows). The electronic device 100 may also include one or more input devices (not shown in FIG. 2) such as a stylus pen, a number pad, a keyboard, a cursor control device, such as a mouse, and/or a joystick, etc., and/or any other device operative to interact with the electronic device 100. Further, the database 322 may serve as a repository for storing data processed, received, and/or generated (e.g., by the module(s) 320).

The processor 302 may be a single processing unit or a number of units, all of which could include multiple computing units. The processor 302 may be implemented as one or more microprocessors, microcomputers, microcontrollers, digital signal processors, central processing units, processor cores, multi-core processors, multiprocessors, state machines, logic circuitries, application-specific integrated circuits, field programmable gate arrays and/or any devices that manipulate signals based on operational instructions. Among other capabilities, the processor 302 may be configured to fetch and/or execute computer-readable instructions and/or data (e.g., the data 314) stored in the memory 304. In an example embodiment, the processor 202 of the electronic device 100 may be integrated with the processor 302 for optimizing the causal device usage parameters of the electronic device 100.

The memory 304 may include any non-transitory computer-readable medium known in the art including, for example, volatile memory, such as static random access memory (SRAM) and/or dynamic random access memory (DRAM), and/or non-volatile memory, such as read-only memory (ROM), erasable programmable ROM (EPROM), flash memory, hard disks, optical disks, and/or magnetic tapes. In an example embodiment, the memory 204 of the electronic device 100 may be integrated with the memory 304 of the electronic device 100 for optimizing the causal device usage parameters of the electronic device 100.

The communication interface unit(s) 306 may enable (e.g., facilitate) communication by the electronic device 100 with the devices 104. The display 308 may display various types of information (for example, media content, multimedia data, text data, etc.) in the form of messages to the user of the electronic device 100. The display 308 may include, but is not limited to, a liquid crystal display (LCD), a light emitting diode (LED) display, an organic LED (OLED) display, a plasma cell display, an electronic ink array display, an electronic paper display, a flexible LCD, a flexible electro-chromic display, and/or a flexible electro wetting display. The display 308 can be a touch enabled display unit or a non-touch display unit. In an example, the electronic device 100 may be the smartphone with or without voice assistance capabilities. The microphones(s) 310 and the speaker(s) 312 may be integrated with the electronic device 100.

The resource(s) 314 may be physical and/or virtual components of the electronic device 100 that provide inherent capabilities and/or contribute to the performance of the electronic device 100. Examples of the resource(s) 314 may include, but are not limited to, memory (e.g., the memory 304), power unit (e.g. a battery), display unit (e.g., the display 308), etc. The resource(s) 314 may include a power unit/battery unit, a network unit (e.g., the communication interface unit(s) 306), etc., in addition to the processor 302, the memory 304, and the display 308.

The camera 316 may be integral or external to the electronic device 100 (therefore illustrated with dashed lines). Examples of the camera 316 include, but are not limited to, a 3D camera, a 360-degree camera, a stereoscopic camera, a depth camera, etc. In an example, the electronic device 100 may be the smartphone and therefore may include the camera 316.

The sensor 318 may be integral or external to the electronic device 100 (therefore illustrated with dashed lines). Examples of the sensor 318 include, but not limited to, an eye-tracing sensor, a facial expression sensor, an accelerometer, a gyroscope, a location sensor, a gesture sensor, a grip sensor, a biometric sensor, an audio module, and/or location/position detection sensor. The sensor 318 may include a plurality of sensors.

The module(s) 320 may include routines, programs, objects, components, data structures, etc., which perform particular tasks or implement data types. The module(s) 320 may also be implemented as, signal processor(s), state machine(s), logic circuitries, and/or any other device and/or component that manipulate signals based on operational instructions.

Further, the module(s) 320 may be implemented in hardware, instructions executed by a processing unit, or by a combination thereof. The processing unit may include a computer, a processor, such as the processor 302, a state machine, a logic array and/or any other suitable devices capable of processing instructions. The processing unit may be a general-purpose processor which executes instructions to cause the general-purpose processor to perform operations or, the processing unit may be dedicated to perform the functions. In another aspect of the present disclosure, the module(s) 320 may be machine-readable instructions (software) which, when executed by a processor/processing unit, may perform any of the described functionalities.

According to some example embodiments, operations described herein as being performed by any or all of the module(s) 206, the modality feature extraction module 210, the intent identification module 212, the information module 214, the beautify module 216, the structural module 218, the modality prediction module 220 and the rendering module 222, may be performed by at least one processor (e.g., the processor 302) executing program code that includes instructions (e.g., the module(s) 206 and/or the module(s) 320) corresponding to the operations. The instructions may be stored in a memory (e.g., the memory 304).

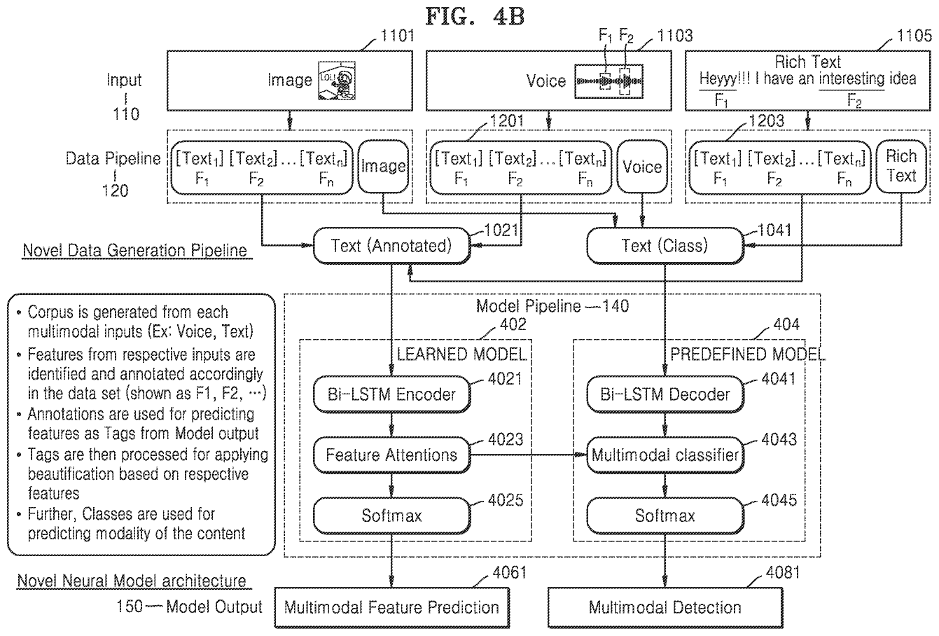

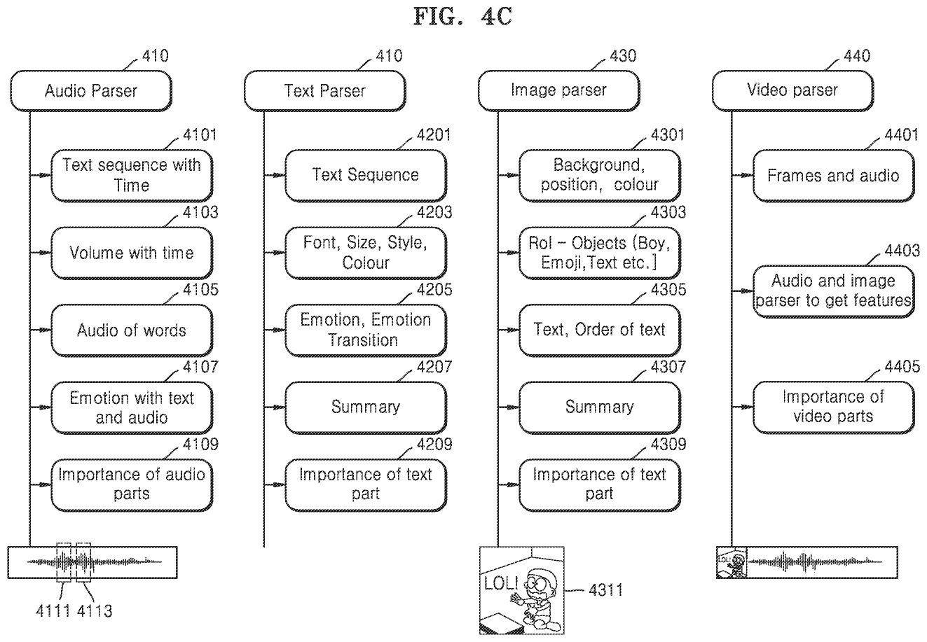

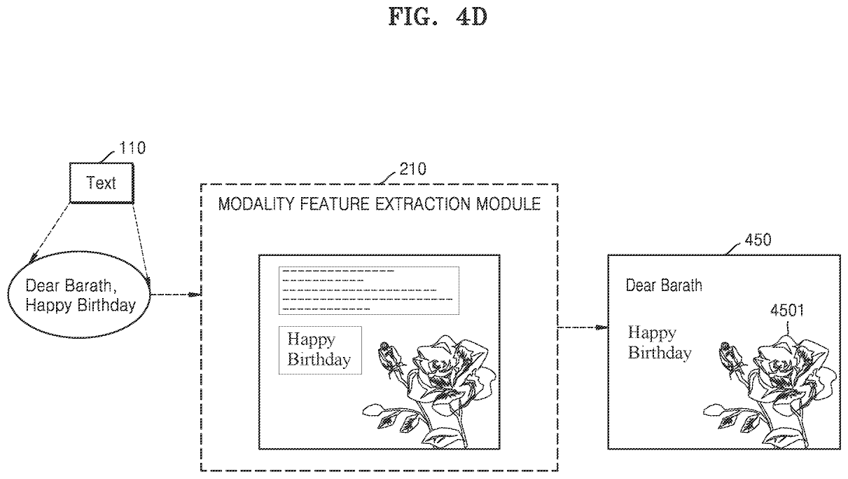

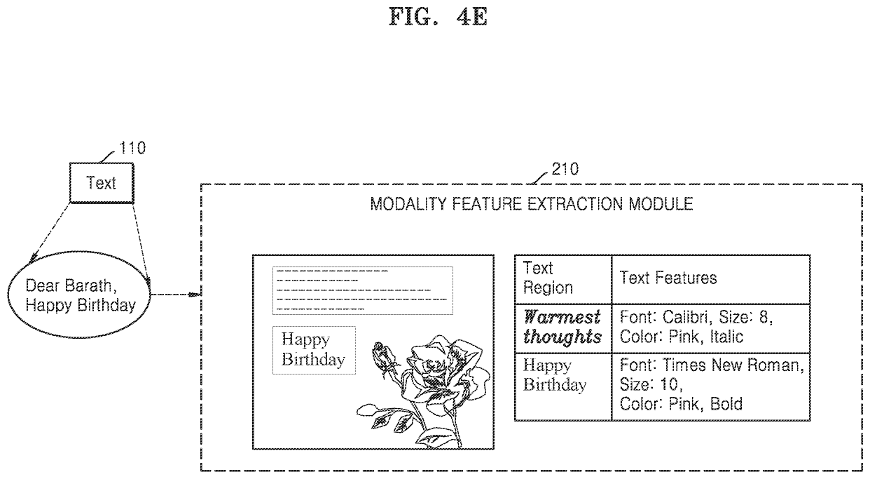

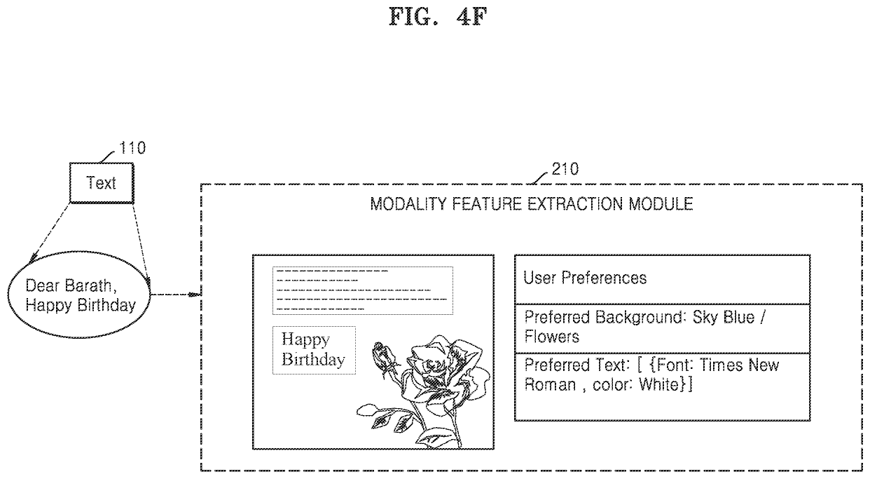

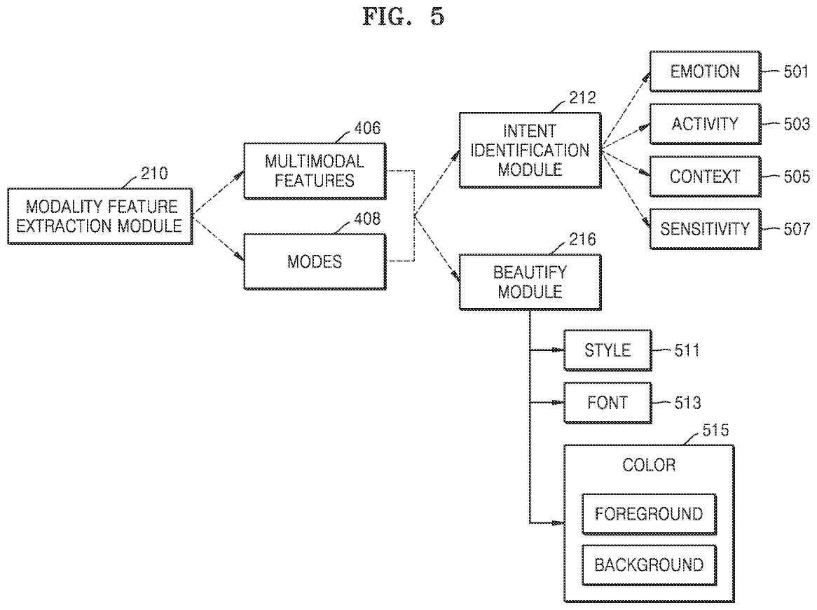

FIGS. 4A and FIG. 4B illustrate detecting modality information and features from the input of the user, according to an embodiment of the disclosure.

Referring to FIG. 4A, the input 110 is obtained from the user 108 which is then sent to the modality feature extraction module 210. The input 110 may include any one or any combination of an image, a voice, a text in Rich Text format (also referred to as “rich text”), and a video. The modality feature extraction module 210 detects the modality of the input 110, among a plurality of modalities including a voice/sound format, a text format, a still image format, and a moving image (e.g., video) format. The modality feature extraction module 210 may obtain the plurality of features from the input 110 by detecting emotion of the user 108, recognizing activity of the user 108 and categorizing the modality and the plurality of features based on the detected emotion, recognized activity, a learned model 402 and a predefined model 404. In an embodiment, the modality feature extraction module 210 detects the modality and the plurality of features from the input 110 by extracting features from the multimedia content such as 1) image: textual features, image features, etc., 2) voice: intonation, stress, text by recognition of the voice, pitch, volume, etc., 3) rich text: textual features such as bold, italic, color, font of the text, etc. The modality feature extraction module 210 may obtain modality information by determining or detecting the modality such as text, voice, image, moving image (e.g., gif image file), video, augmented reality, virtual reality, extended reality, or a combination thereof from the input 110. The modality feature extraction module 210 may identify features from respective inputs and annotate accordingly.

Referring to FIG. 4B along with FIG. 4A, a process of feature extractions is shown in detail according to an embodiment of the disclosure.

In the data pipeline 120, text features are extracted from the input 110 including at least one of an image 1101, a voice (or a voice signal) 1103, and/or a rich text 1105. As shown in FIG. 4B, corpus is obtained from the input 110. The features from the input 110 may be identified and the features are annotated accordingly in the data set shown as F1 [Text1], F2[Text2] Fn[Textn] in the data pipeline 120. For example, the modality feature extraction module 210 may extract a first part F1 and a second part F2 of the voice signal 1103 which have amplitudes greater than a predetermined value, may convert the voice included in the first part F1 and the second part F2 into the Text1 and the Text2, and may associate the first part F1 and the second part F2 of the voice signal 1103 with the Text1 and the Text2, respectively.

The non-text features such as image, voice, stress, textual features are classified. Thereafter, these annotations and classifications are used for predicting features as tags using the learned model 402 and the predefined model 404 which are then processed for applying beautification at a later stage based on respective features. The learned model 402 may include Bi-LSTM Encoder 4021, feature attentions 4023 and Softmax 4025. The pre-defined model 404 may include Bi-LSTM Decoder 4041, multimodal classifier 4043(using information of feature attentions 4023) and Softmax 4045. Further, these tags are mapped to form classes which are used for predicting modes 408 and multimodal features 406 of the input 110.

FIG. 4C illustrates a list of features from the input 110 according to an embodiment of the disclosure.

The audio parser 410 may parse audio input included in the input 110 and extract features such as a text sequence along with corresponding time points 4101, volume with time points 4103, words in the audio sound (Audio of words 4105), emotion with text and audio 4107, and/or importance of text parts 4109.

In an embodiment, the importance of text parts 4109 may be determined with a combination of the text sequence along with time points 4101 and the volume corresponding to each of time points 4103. For example, a certain text (e.g. Text1 1201 as shown in FIG. 4B) within the text sequence with time point t1 has relatively large volume such as 4111 and 4113, the text(Text1) may be determined to be of high importance compared to other text parts within the text sequence. In an embodiment, emotion (or mood) with text and audio 4109 may be extracted based on predetermined words such as sad, happy, joy(ful), wow, delight(ful), angry etc. The audio parser 410 may refer to the database 208 containing the predetermined words representing the emotion to determine whether the certain text (e.g. Text1) corresponds to the predetermined words of the emotion stored in the database 208.

In an embodiment, the text parser 420 may extract or detect features from the text included in the input 110. The features extracted from the text included in the input 110 may include the text sequence 4201, font/size/style/color of the text 4203, emotion/emotion transition 4205, summary 4207, and/or importance of text part 4209. In an embodiment, the importance of text part 4209 may be determined based on any of the foregoing features extracted from the text. For example, if the font, size, style (e.g. italics), and/or color of a certain text (e.g. Text2 1203 as shown in FIG. 4B) is different from other text part, the Text2 may have higher importance among the text included in the input 110.

In an embodiment, the image parser 430 may extract or detect features from the image included in the input 110. The features extracted from the image included in the input 110 may include background/position (of text and/or an object in the image)/color 4301, a region of interest (ROI) 4303, text/order of text 4305, summary 4307, and/or importance of image parts 4309. In an embodiment, the importance of image parts 4309 may be determined based on any of the foregoing features extracted from the image included in the input 110. For example, the text “LOL” included in the image 4311 may represent the emotion extractable from the image and the text “LOL” may be regarded as the feature of high importance. The electronic device 100 may store a list of words or variations thereof (e.g., “LOL”), in the database 322, which are classified as important words or emotion words.

The video parser 440 may parse video input included in the input 110 and extract features such as frames and audio 4401 and/or importance of video parts based on a rate of scene changes, volume of each scene, etc. Features extractable by the audio parser 410 and the image parser 420 may also be extracted by the video parser 440.

The audio parser 410, the text parser 420, the image parser 430, and the video parser 440 may be a part of the modality feature extraction module 210 and/or the processor 202.

FIG. 4D, FIG. 4E, and FIG. 4F illustrate generating customized content, according to an embodiment of the disclosure.

Referring to FIG. 4D, a text customization by the modality feature extraction module 210 is illustrated. For instance, the input 110 obtained by the modality feature extraction module 210 may be an image, GIF image (short moving image, or short animation frames) or text. The modality feature extraction module 210 modifies the text in the image or GIF to generate an output image or an output GIF with modified text in the region without affecting image quality.

For example, assuming that the text in the input 110 recites “Dear Barath, Happy Birthday”, the modality feature extraction module 210 detects a textual format as modality information from the input 110 and extracts features such as happy-minded emotion based on the words of “happy birthday” included in the text. The electronic device 100 may generate customized content 450 with an image of flower(s) 4501 suitable for the mood of happy-minded and the words of “happy birthday”. The customized content 450 may also include the original text of “Dear Barath, Happy Birthday” in an appropriate position in the customized content 450. The electronic device 100 may perform an Internet search using a keyword “happy” to find an image (e.g., the image 4501) related to the emotion of happiness, or search a local storage (e.g., the memory 204 or the database 208) to find an image related to the happiness emotion.

Referring to FIG. 4E, a font/color detection by the modality feature extraction module 210 is illustrated. For instance, the input 110 obtained by the modality feature extraction module 210 may be an infographic image including the text. The modality feature extraction module 210 recognizes the features included in the text and is ready to generate an output with customized text features. When the color of the text in the input 110 is pink, the electronic device 100 may recognize the pink color, determine the mood based on the pink color , and then determine to include pink or red flowers suitable for the determined mood in the customized content.

Referring to FIG. 4F, a user preferred customization by the modality feature extraction module 210 is illustrated. For instance, the input 110 obtained by the modality feature extraction module 210 may be an image, GIF, Audio, Video. The electronic device 100 may apply user style to the input and generate a customized image, GIF or video based on user style preference. The user style may be detected and learned with the input 110 and/or may be extracted from the database 208.

FIG. 5 illustrates a process of identifying intent from the input and beautifying customized content according to an embodiment of the disclosure.

Referring to FIG. 5, the predicted modes 408 and multimodal features 406 obtained from the modality feature extraction module 210 are then sent to the intent identification module 212 and beautify module 216. The intent identification module 212 identifies intent of the input from the detected plurality of features from the input 110 which is one of emotion, activity, content, sensitivity and a combination thereof. The emotion 501 may be obtained using a Deep Neural Networks (DNN) used to predict the emotion out of expressions detected in the input 110. The context 505 may be an event, a point of interest searched or being searched by the electronic device 100 or a location of the electronic device 100, a payment conducted using the electronic device 100 detected based on the content of the input 110. The sensitivity 507 may be positive, negative, or neutral determined based on the mood of the text. The activity 503 may be development. As an example, the text of “happy birthday” may be interpreted to derive, by the intent identification module 212, the intent of “congratulating somebody” who will be determined by another text representing a name “Barath” referring back to FIG. 4D.

The smiling face with expressions such as winking, grinning, and rolling on the floor laughing may be classified into one category of “smiling face” in an embodiment. A pre-existing image recognition method may be used for recognizing the mood extractable from the image. The beautify module 216 receives the detected multimodal features 406 and modes 408 as an input to generate one or more layout templates for the multimodal content. The one or more layout templates include style 511 of texts, font 513 of texts, and color 515 of foreground and background of the multimodal content 112.

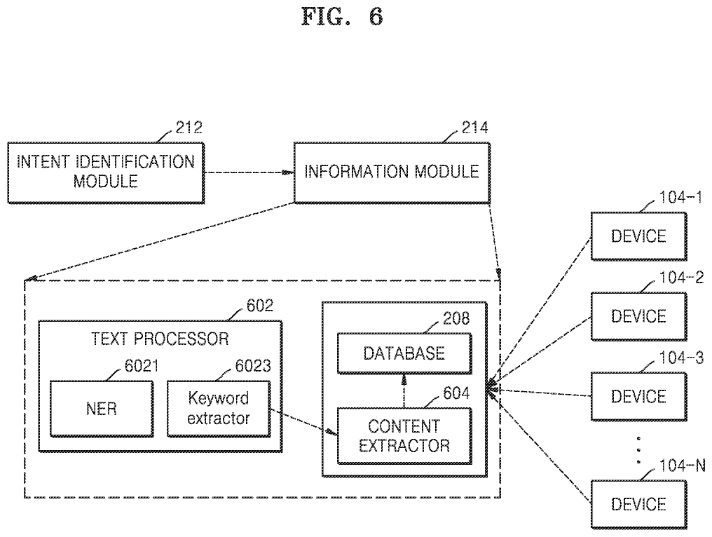

FIG. 6 illustrates retrieving information to generate customized content according to an embodiment of the disclosure.

Referring to FIG. 6, in an embodiment, the identified intent of the input which is one of emotion, activity, context, sensitivity and a combination thereof obtained by the intent identification module 212 is then forwarded to the information module 214. The information module 214 extracts at least one keyword from the received intent of the input 110 and searches the database 208 of the electronic device 100 and other connected devices 104 for information based on the at least one keyword. In an embodiment, the information module 214 may extract keywords from the input 110 to determine “Who, What, When, Where, Why, and How” as the information. In an embodiment, the text processor 602 including Named-entity recognition (NER) 6021 and a keyword extractor 6023 to extract at least one keyword from the received intent of the input 110. The at least one keyword retrieved by the text processor 602 is then sent to the content extractor 604 which searches the database 208 of the electronic device 100 and/or other connected devices 104 for the information (“Who, What, When, Where, Why, and How”) based on the at least one keyword.

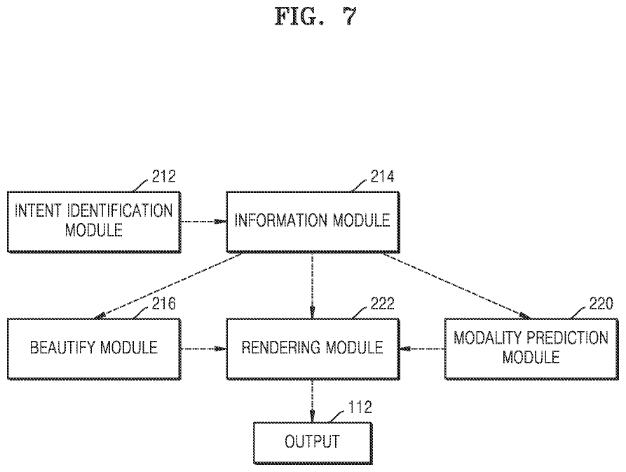

FIG. 7 illustrates a process of generating customized content according to an embodiment of the disclosure.

Referring to FIG. 7, in an embodiment, the output from the information module 214 is sent to the beautify module 216, rendering module 222 and/or modality prediction module 220. The beautify module 216 uses the output obtained from the information module 214 to map the retrieved information to the generated one or more layout templates. The modality prediction module 220 uses the information received from the information module 214 to predict the mode of the multimodal content 112 using a neural network (NN). The information received from the information module 214, the mode predicted by the modality prediction module 220 and the one or more layout templates mapped with the retrieved information by the beautify module 216 are sent to the rendering module 222. The rendering module 222 generates a multimodal content 112 based on at least one of the detected modality, the plurality of features, the retrieved information and/or the one or more layout templates mapped with the retried information.

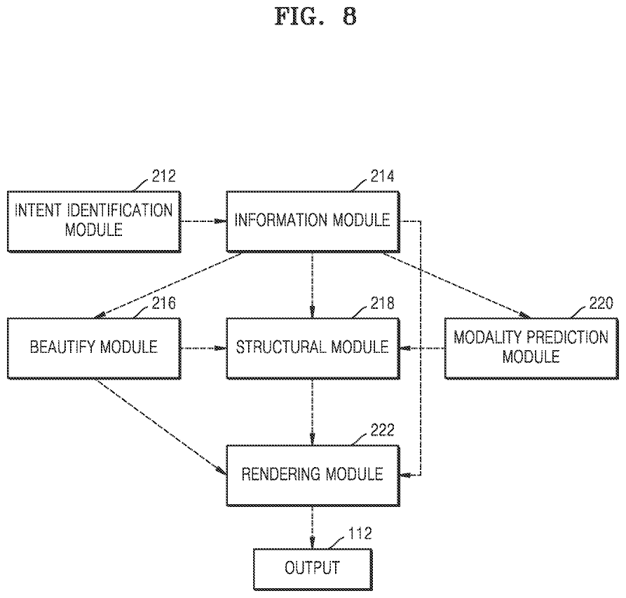

FIG. 8 illustrates a process of generating customized content according to another embodiment of the disclosure.

Referring to FIG. 8, a structural module 218 is shown. In an embodiment, the output from the information module 214 is also sent to the structural module 218. The structural module 218 receives an unstructured data in an order as the input 110 from the user 108. The structural module 218 stores the un-structured data in a semi-structured form in the received order and thereafter, maps the semi-structured data to the one or more layout templates each of which is generated for different display layout formats by the beautify module 216. The beautify module 216 may take structural data as input to change the beautify parameters and generate different display layout formats. In embodiment, the information received from the information module 214, the mode predicted by the modality prediction module 220, the one or more layout templates mapped with the retrieved information by the beautify module 216 and the mapped semi-structured data from the structural module 218 are sent to the rendering module 222. The rendering module 222 generates a multimodal content (e.g., customized content) 112 based on at least one of the detected modality information and the plurality of features from the input 110, the retrieved information, the one or more layout templates mapped with the retrieved information, the one or more layout templates mapped with the semi-structured data and the predicted modality for a display layout format based on the learned model and a predefined model.

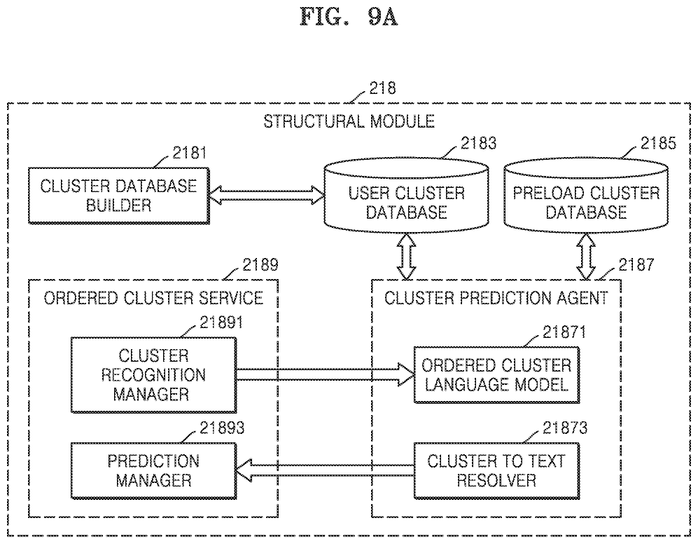

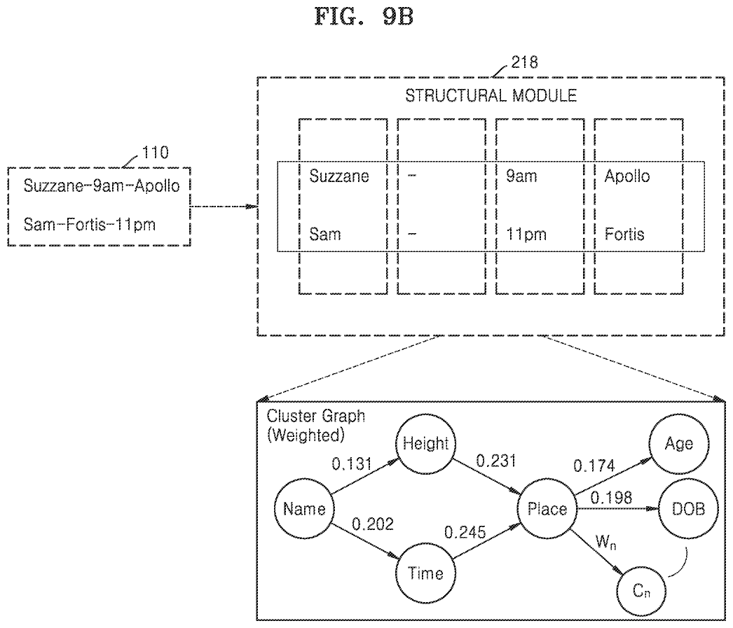

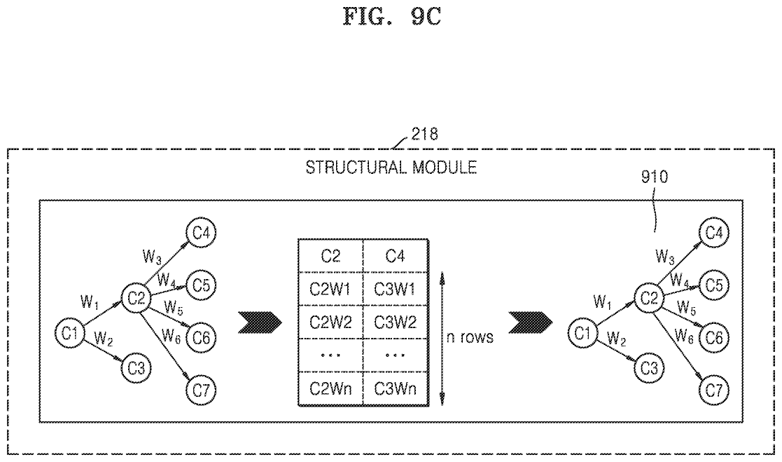

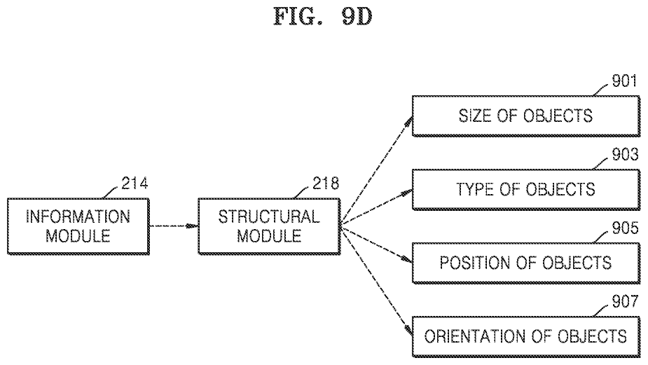

FIG. 9A illustrates the structural module 218 according to an embodiment of the disclosure. of the structure module 219 includes a cluster database builder 2181 with data segregated into groups such as contacts, email-ids, name etc. The cluster database builder 2181 interacts with a user cluster database 2183 and a preload cluster database 2185 to create data clusters. The user cluster database 2183 and the preload cluster database 2185 in turn interacts with 1 cluster prediction agent 2187. The cluster prediction agent 2187 interacts with an ordered cluster service 2189. The ordered cluster service 2189 includes a cluster recognition manager 21891 and a prediction manager 21893. The cluster recognition manager 21891 creates cluster ID using the unstructured text and sends it to the ordered cluster language model 21871 of the cluster prediction agent 2187. The ordered cluster language model 21871 generates next cluster ID and sends it to a cluster to text resolver 21873. The information generated by the cluster prediction agent 2187 is then sent to the user cluster database 2183 and the preload cluster database 2185 which is in turn sent to the user cluster database builder to form clusters.

FIG. 9B illustrates an exemplary operation performed by the structural module 218 in the electronic device according to an embodiment of the disclosure.

Referring to FIG. 9B, the input 110 from user 108 is semi-structured data including, for example, Suzzane-9am-Apollo; Sam-Fortis-11pm. The structural module 218 identifies the cluster of data and accordingly arranges the input 110 into a structured form. The cluster of data may indicate an identification data such as Suzzane and Sam, time data such as 9 am and 11 pm, and location data such as Apollo and Fortis in the input 110. The cluster of data may extend to additional kinds of data identified in the input including, but not limited to, product data such as name of product (ice cream, eggs, cake, TV, etc.), event data such as anniversary (e.g., birthday and wedding anniversary, funeral), intent data (e.g., coming home, staying at the library, going to a restaurant, etc.) and state data (e.g., sleepy, drowsy, tired, excited, wow!, great!, etc.). The entries are extracted from input 110 and then classified into cluster of data using Named Entity Recognition (NER) and the corresponding Cluster IDs are stored in a temporary buffer such as memory 204 to maintain a cluster order. The cluster order from previous row is used for identifying next cluster in the table.

FIG. 9C illustrates the cluster of data formed by the structural module 218 to obtain a semi-structured data as an output according to an embodiment of the disclosure. The input 110 received from the user 108 is parsed to identify the structure of the input 110. The parsing of the input 110 includes analyzing existing ordered cluster, analyzing the delimiter and maintains the cluster by storing the input based on the cluster type. Accordingly, the cluster ordering is maintained in the cluster graph 910.

FIG. 9D illustrates structural engine positioning objects based on the information received from the information module 214 according to an embodiment. The structural module 218 decides a size of objects 901, a type of objects 903, positions of objects 905 and an orientation of objects 905 and places it in a structural format.

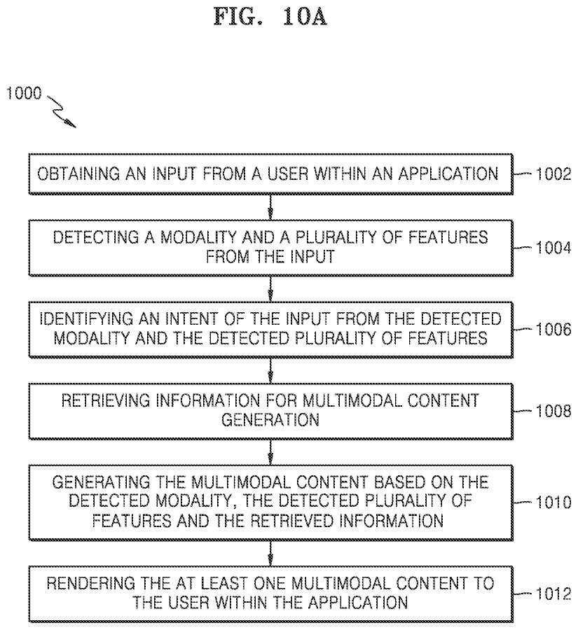

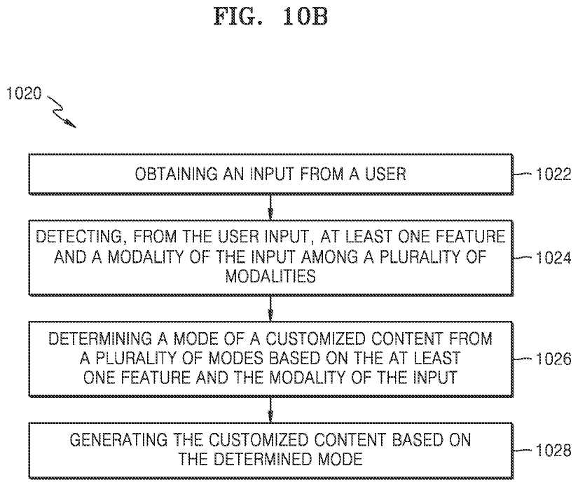

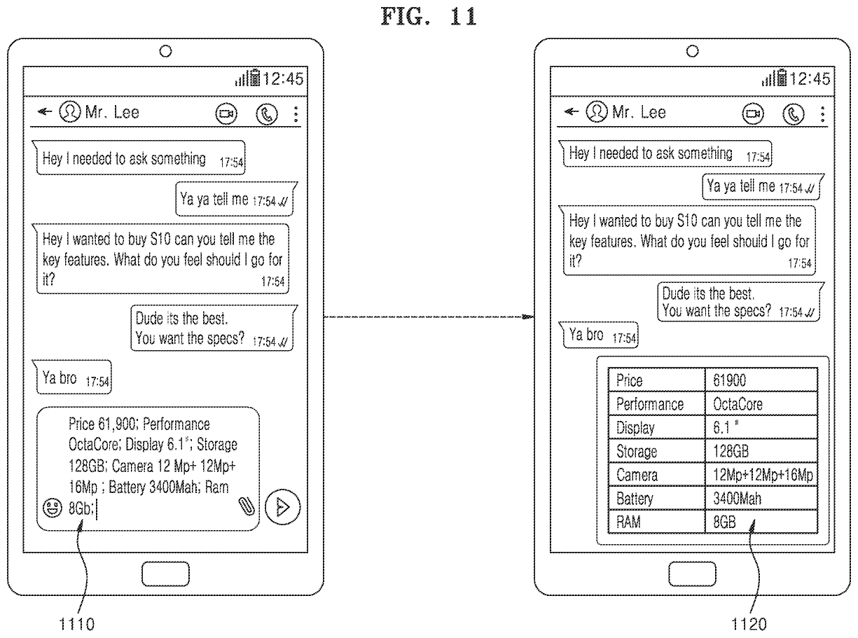

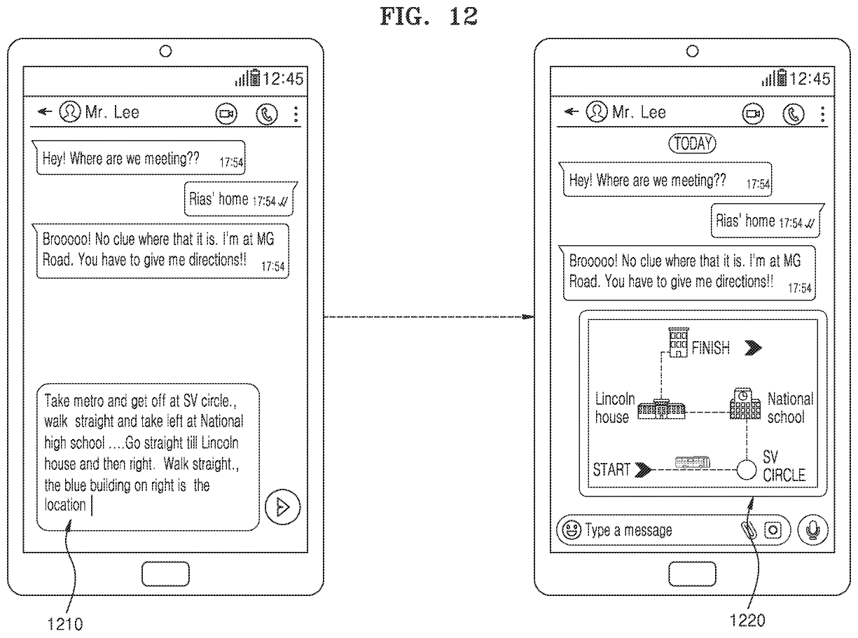

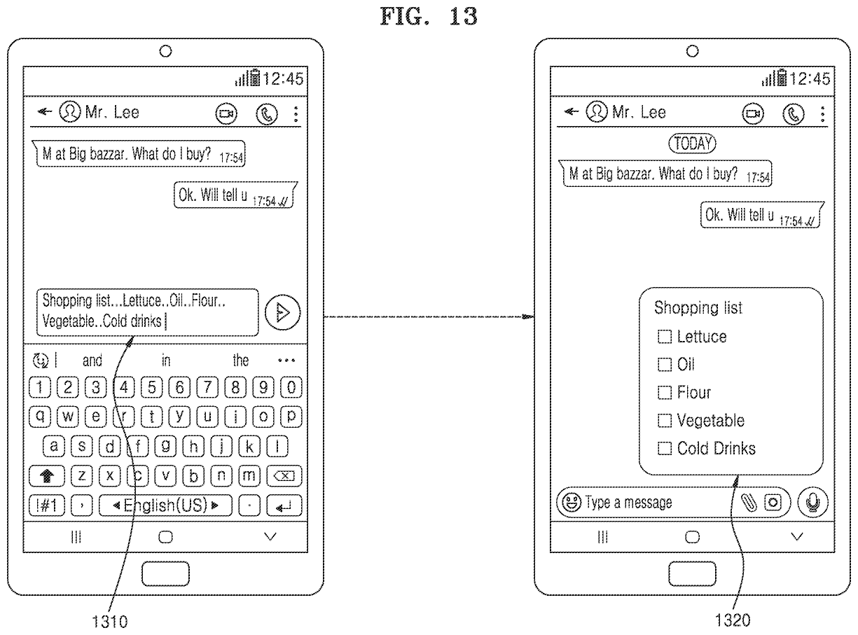

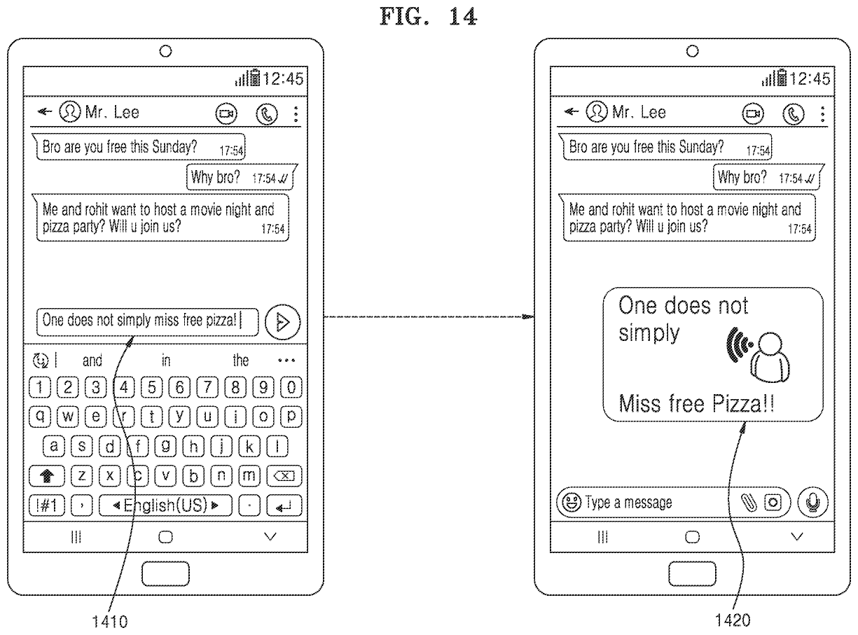

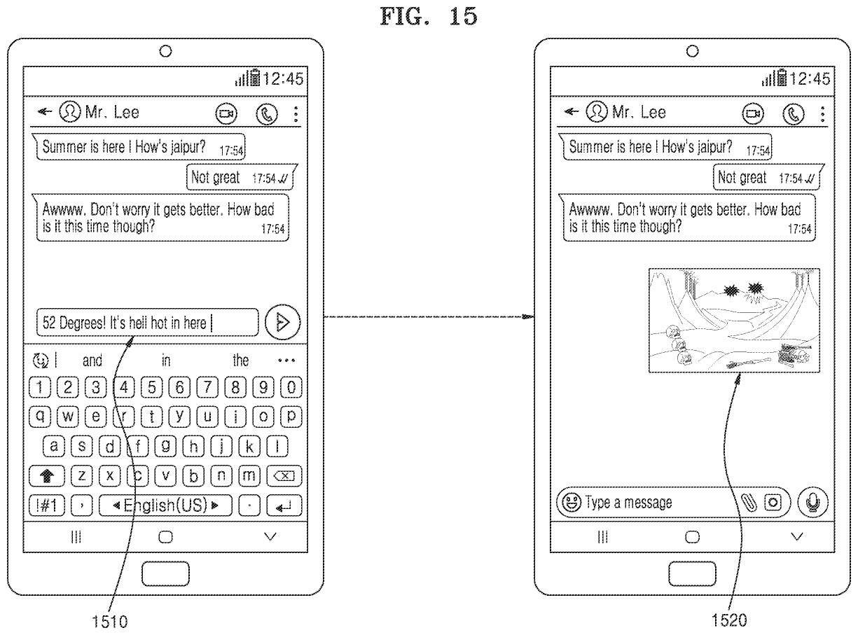

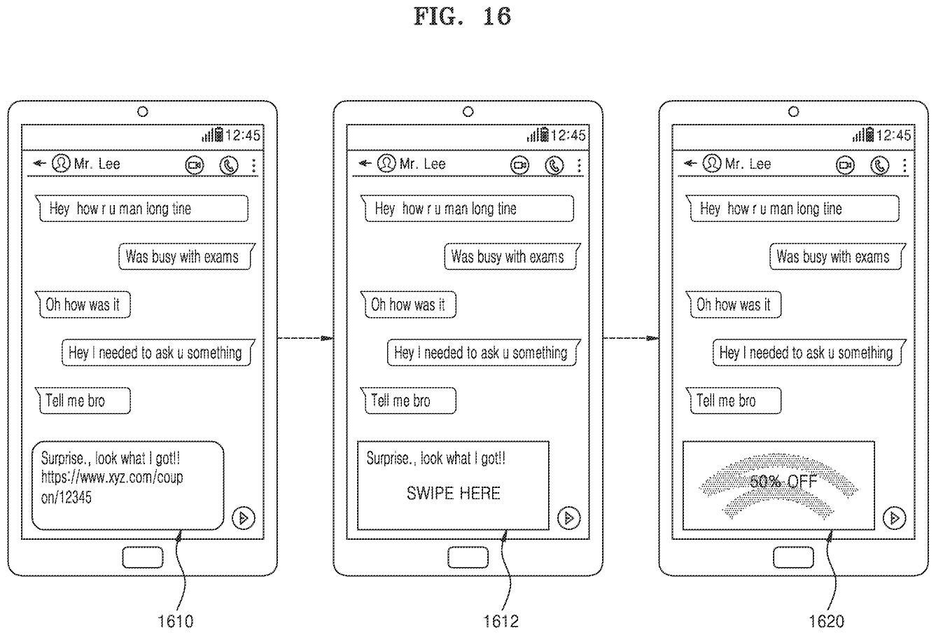

FIG. 10A illustrates a flowchart for multimodal content generation based on user input, according to an embodiment of the disclosure.

The electronic device 100 receives an input 110 from a user within an application at step 1002. Further, at step 1004, the electronic device 100 detects or extracts modality information and a plurality of features from the input 110. The detecting of the modality (modality information) and the plurality of features from the input 110 includes detecting emotion of the user, recognizing activity of the user and categorizing the modality and the plurality of features based on the detected emotion, recognized activity, learned model and a predefined model. At step 1006, the electronic device 100 identifies intent of the input 110 from the detected modality and the plurality of features. At step 1008, the electronic device 100 retrieves information for multimodal content generation and at step 1010, the electronic device 100 generates the multimodal content based on the detected modality, the detected plurality of features and the retrieved information. The retrieving of the information includes receiving the intent of the input, extracting at least one keyword from the received intent of the input and/or searching the information based on the at least one keyword in an internal database of the electronic device 100 and/or other connected devices. At step 1012, the electronic device 100 renders the generated multimodal content to the user. The user may select at least one multimodal content if a plurality of multimodal contents are generated and shown on a display 308 of the electronic device 100.

FIG. 10B illustrates a flowchart for multimodal content generation based on a user input, according to an embodiment of the disclosure.

The electronic device may obtain an input 110 from a user at step 1022. The input 110 may be obtained via an application installed in the electronic device 100. The processor 202 of the electronic device 100 may detect, from the user input 110, at least one feature and a modality of the input among a plurality of modalities at step 1024. The modalities may include at least one of a text format, a sound format, a still image format, and a moving image format. The detection of the at least one feature and the modality of the input may include detecting an emotion or an activity of the user based on texts recognized in the input 110 and categorizing the modality and the at least one feature based on the detected emotion of the user or the detected activity of the user. The categorization may be performed based on a learned model and a predefined model. In an embodiment, the processor 202 may obtain intent information based on texts extracted from the input 110. Based on the intent formation, the processor 202 may determine at least one of a font size, a font type, and a color of the texts. Based on the intent information, the processor 202 may a layout of the customized content. In an embodiment, the processor 202 may obtain at least one of time information and location information from the input 110. In an embodiment, the processor 202 may determine that the customized content requires an intervention of the user and in response to the intervention of the user, the processor 202 may control to display a second customized content.

The processor 202 of the electronic device 100 may determine a mode of a customized content from a plurality of modes based on the at least one feature and the modality of the input 110 at step 1026. The plurality of modes may include an image mode and a text mode. The customized content may be generated further based on the detected emotion of the user.

The processor 202 of the electronic device 100 may generate the customized content based on the determined mode at step 1028. The customized content may be generated further based on the extracted texts and the determined mode. The customized content may be generated further based on the determined mode and the at least one of a font size, a font type, and a color of the texts. The customized content may be generated further based on the determined mode and the determined layout. The customized content may be generated based on the determined mode and the at least one of the time information and the location information.

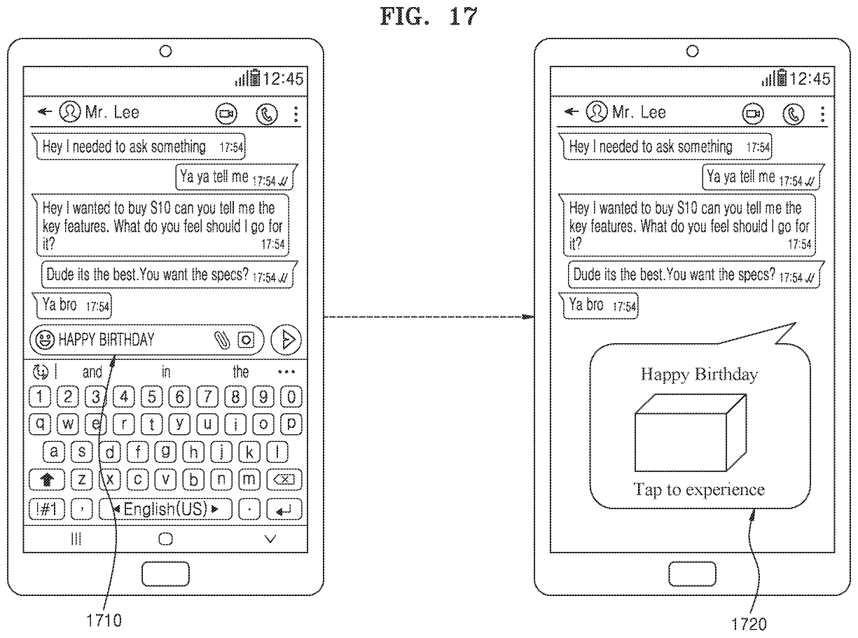

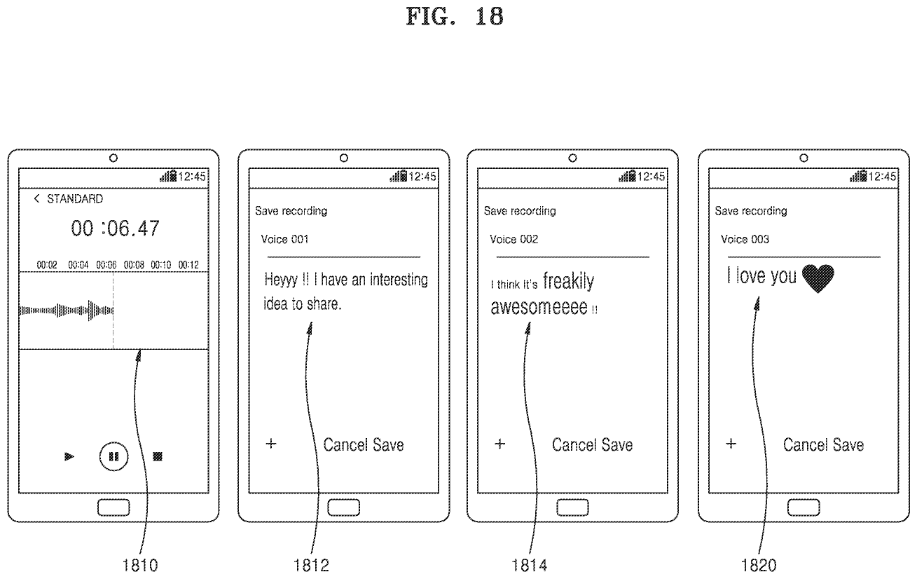

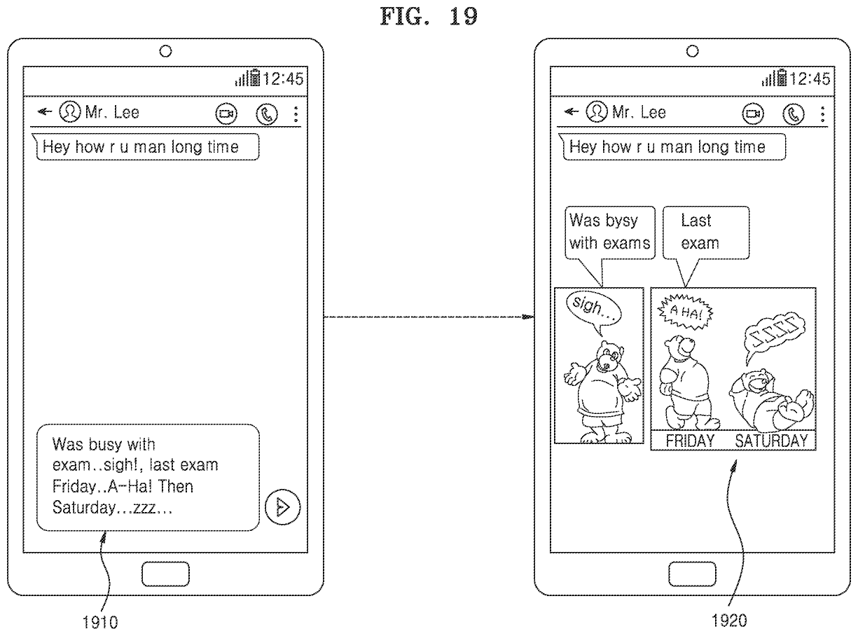

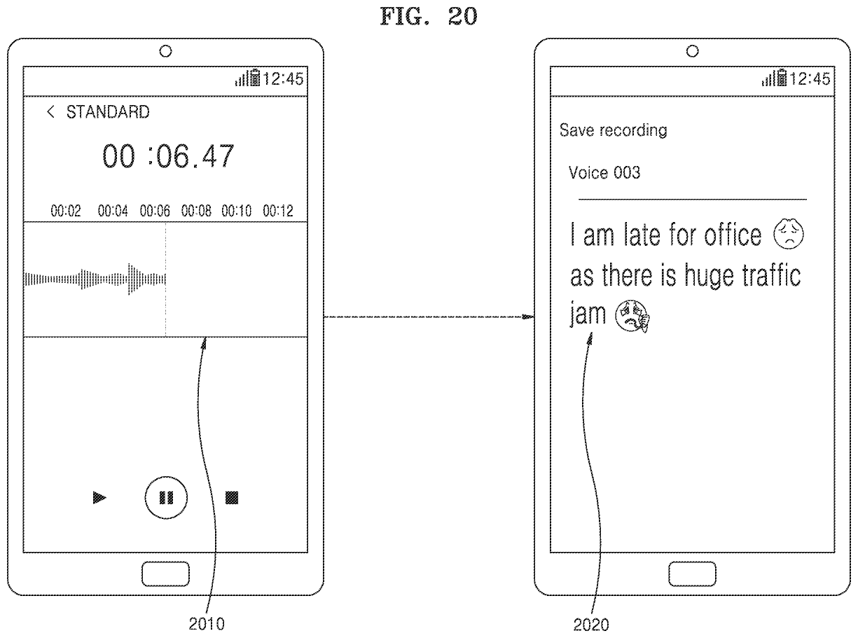

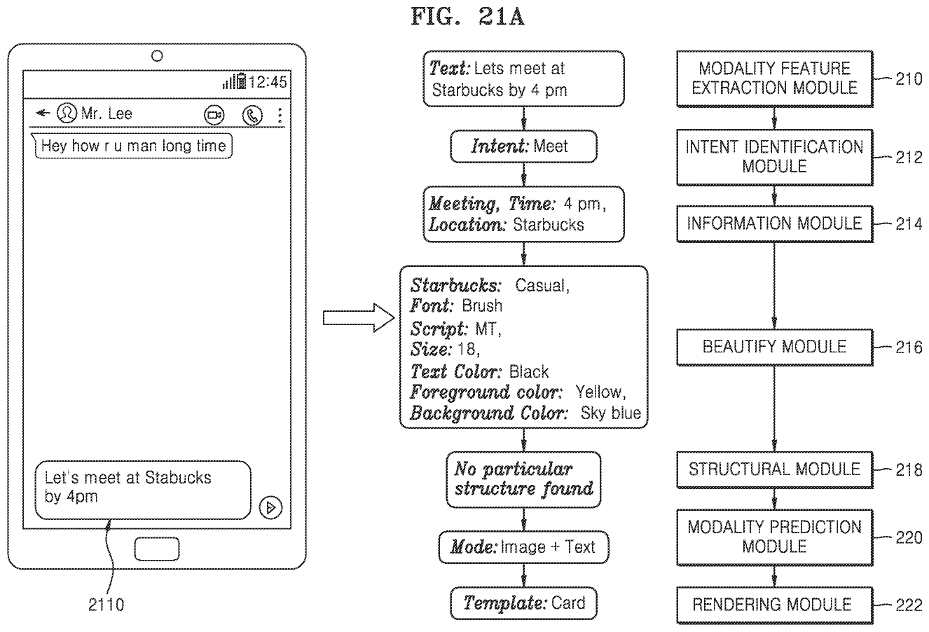

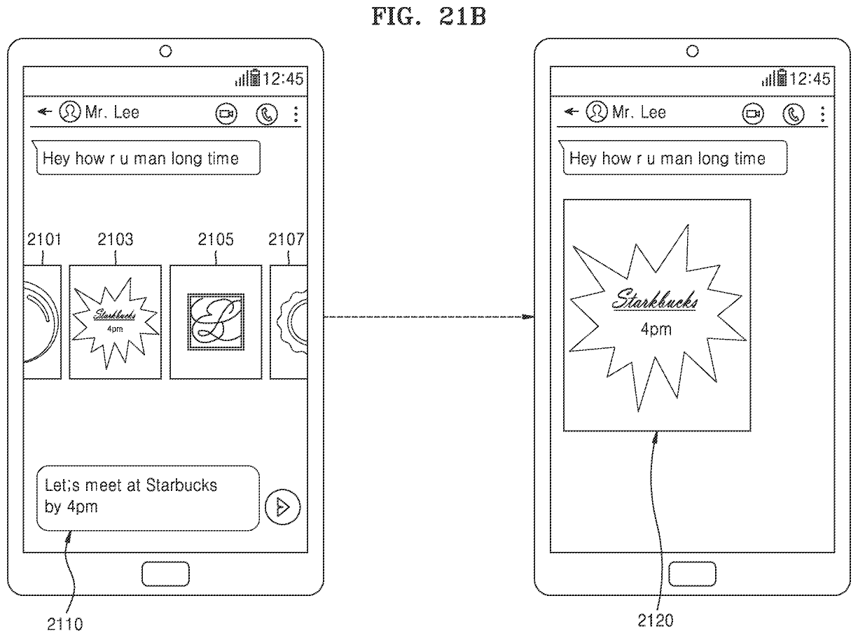

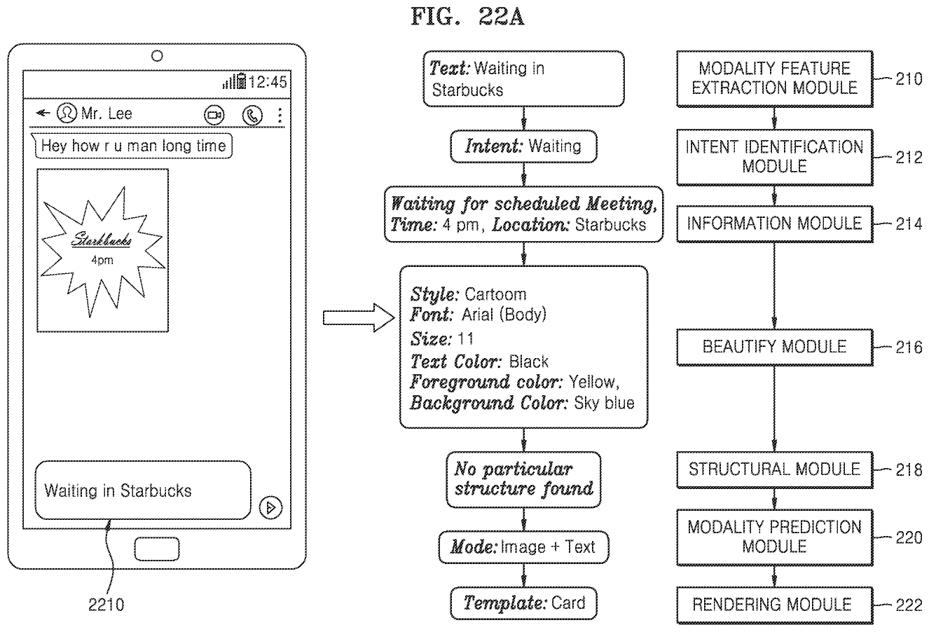

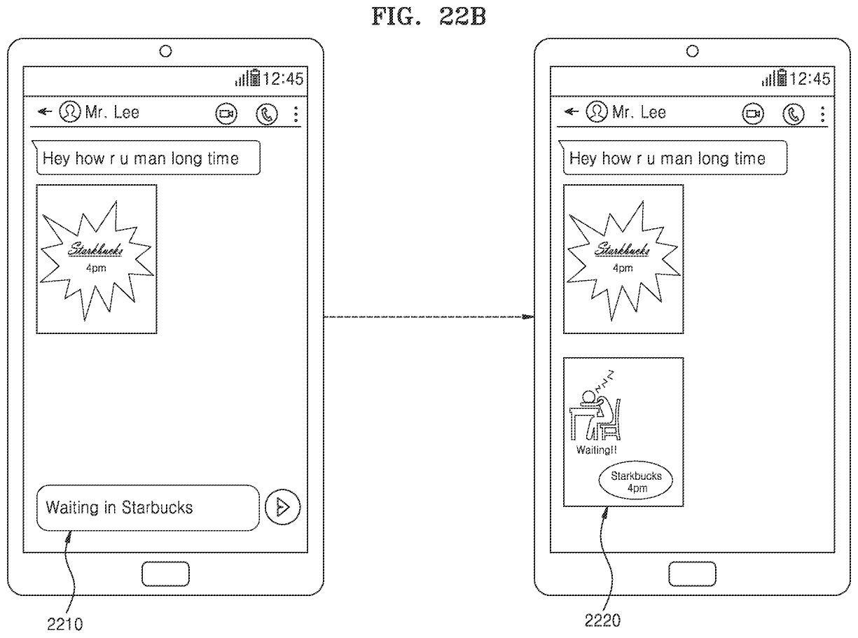

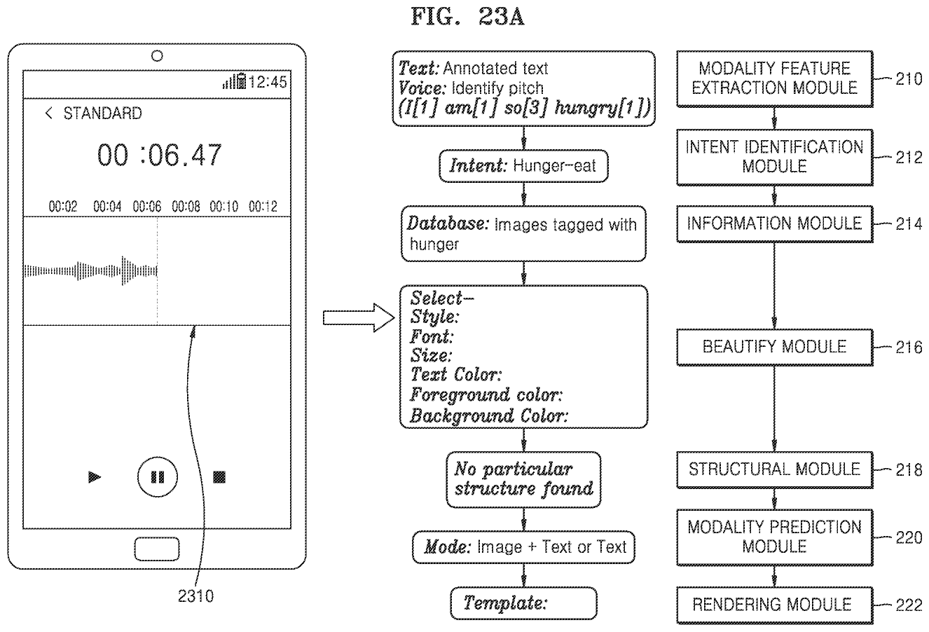

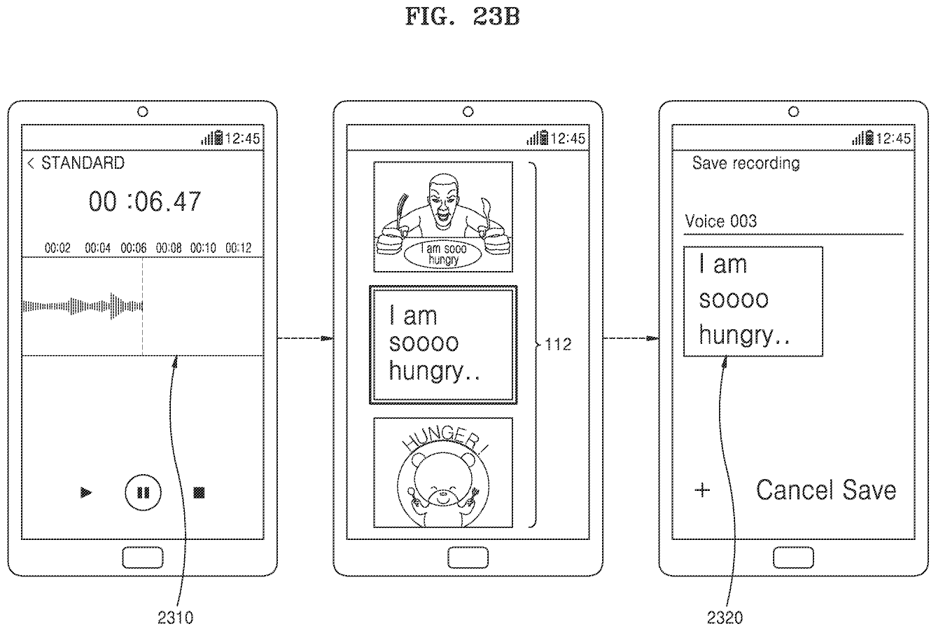

FIG. 11, FIG. 12, FIG. 13, FIG. 14, FIG. 15, FIG. 16, FIG. 17, FIG. 18, FIG. 19, FIG. 20, FIG. 21, FIG. 22, and FIG. 23 illustrate an example of generating multimodal content by the electronic device according to embodiments of the disclosure.

Referring to FIG. 11, the user 108 enters, in a text message application, the specification of a mobile device which reads “Price 61,900; Performance OctaCore; Display 6.1”; Storage 128 GB; Camera 12 Mp+12 Mp+16 Mp; battery 3400 Mah; Ram 8 Gb″ as an input 1110. The electronic device 100 may recognize the input of semi-structured form to generate a multimodal content 1120 as an output in a structured tabular form. The electronic device 100 may recognizes the input 1110 as one of the specification based on a combination of the terms included in the input 1110—price, octacore, display, storage (term representing storage size such as GB), camera, battery, and RAM. Since the terms of “price, octacore, or storage size(GB)” usually appear in the PC specification, thus the electronic device 100 may use the structured tabular form to display the specification as customized content 1120 on the display 308 of the electronic device 100.

Referring to FIG. 12, the user 108 enters the direction of a location. For instance, the direction given as an input 1210 by the user 108 is “Take metro and get off at SV circle., walk straight and take left at National High School . . . Go straight till Lincoln house and then right. Walk straight . . . the blue building on right is the location”. The electronic device 100 recognizes this input 1210 as a direction guide to the recipient and accordingly generates a multimodal content 1220 as an output in the form or the layout of info-graphic representation for easy understanding of the direction guide. The electronic device 100 may recognize the input 1210 as the direction guide based on a combination of expressions used for the direction guide such as “take, get off, turn right, turn left, go straight, walk straight, and go along” and the name of various locations following the terms for the direction guide.

Referring to FIG. 13, the user 108 enters a shopping list in a text message application as an input 1310. The input 1310 recites “Shopping list . . . Lettuce . . . Oil . . . Flour . . . vegetable . . . Cold drinks”. The electronic device 100 recognizes this input 110 as the intent of ‘shopping’ and accordingly stylizes the text into relevant interactive media format to generate a multimodal content 1320 as output in the form or the layout of check-list on which user may mark a tick on the purchased goods as shown in FIG. 13.

FIG. 14 illustrates an exemplary operation performed by the electronic device. In the illustrated example, the user 108 enters a quote during the communication as an input 1410. The input 1410 entered by the user 108 is “One does not simply miss free pizza”. The electronic device 100 recognizes this input 1410 and accordingly generates a multimodal content 1420 as an output in the form of an appropriate memo with the quote.

Referring to FIG. 15, the user 108 enters a quote during the communication as an input 1510. The input 1510 entered by the user 108 is “52 degrees! Its hell hot here.”. The electronic device 100 recognizes this input 1510 and accordingly generates multimodal content 1520 as an output in the form of an appropriate GIF with the quote mentioned on it as illustrated. In particular, the electronic device 100 may recognize the term of “degrees” as an indication of “temperature” by combining the neighboring term of “52” and may recognize the terms of “hell” and “hot” as an indication of extremely hot weather. The electronic device 100 may search the database 208 or other connected devices 104 for a GIF representing ‘hot weather’ or ‘extremely hot condition’.

Referring to FIG. 16, the user 108 enters a link of coupon for redemption during the communication as an input 1610. The input 1610 entered by the user 108 is “Surprise, look what I got!! https://www.xyz.com/coupon/12345”. The electronic device 100 recognizes this input 1610 as requiring a user intervention and accordingly, generates a first multimodal content 1612 as an output in the form of a scratch card requesting a user's intervention by asking to “swipe!” as illustrated. In response to the user's swiping the scratch card, the coupon as a second multimodal content 1620 is displayed.

Referring to FIG. 17, the user 108 enters the text “Happy Birthday” during the communication as an input 1710. The electronic device 100 recognizes this input 1710 and accordingly generates multimodal content 1720 as an output in the form of an Augmented Reality experience that is relevant to the text.

Referring to FIG. 18, the user 108 enters a voice input 1810 during the communication. When the user enters the voice input 1810, the same is recognized and converted into rich text 1812 and 1814. The electronic device 100 also identifies important words based on the volume of the voice input 1810 and stylizes the text based on words and corresponding meaning, indications and corresponding volume in the voice input 1810 appropriately further based on the identified intent of the voice input 1810. The stylization of the words may include changing of color, a font, a size, a font type such as bold and italics of the words(texts). The color, font, size, and/or font type of the words(texts) may be collectively classified as text information. Accordingly, the electronic device 100 generates, based on the text information, a multimodal content 1820 as rich text with emoticons if required. When the user pastes the rich text in messaging platform which does not support rich text, electronic device 100 understands and detects multimodality and sends the content as an image.

Referring to FIG. 19, the user 108 enters a sentence such as “busy with exam . . . sigh!, last exam on Friday . . . A-Ha! Then Saturday . . . zzz . . . ” as an input 1910. The electronic device 100 recognizes this input 1910 and understands the intent of the user and accordingly generates multimodal content 1920 as comic narrative or at least one image of which content corresponds to the intent of the user. The comic narrative or the at least one image may be obtained at the database 208 of the electronic device 100 or at the connected devices 104 via networks.

Referring to FIG. 20, the user 108 enters a voice message as an input 2010. The electronic device 100 predicts emoji to be inserted in the sentence automatically when the electronic device 100 recognizes the voice input 2010, converts the voice input 2010 to a rich text, and recognizes the meaning and the tone of the words included in the rich text. For instance, the voice input 2010 is “I am late for office as there is huge traffic jam”. The electronic device 100 recognizes this input 2010 and understands the intent and the state of mind of the user as frustration and regret. Accordingly, the electronic device 100 generates multimodal content 2020 including “I am late for office <emoji> as there is huge traffic jam <emoji>” as an output, as shown in FIG. 20. The electronic device 100 understands at which point to insert an emoji even though input 2010 is not properly structured.

FIG. 21A and FIG. 21B illustrate an exemplary operation performed by the electronic device 100 to compose a message according to an embodiment of the disclosure. Referring to FIG. 21A, user 108 enters an input 2110 of “Lets meet at Starbucks by 4 pm”. The modality feature extraction module 210 recognizes the input 2110 as text, the intent identification module 212 recognizes the intent as “Meet”. In general, the intent of the user may be extracted by detecting at least one verb (e.g., meet), adjective (e.g., hungry), texts corresponding to time, texts corresponding to a place or location and. The information module 214 recognizes and/or obtains the meeting time: 4 pm and location: Starbucks. The beautify module 216 predicts and/or determines the layout template: Style: Casual, Font: Brush Script MT, Size: 18, Text Color: Black; Foreground color: Yellow, Background Color: Sky blue. The structural module 218 determines that no structure found. The modality prediction module 220 determines the mode of the multimodal content to be an image and text mode and accordingly, the rendering module 222 generates a card template for the multimodal content 2120 as an output in FIG. 21B.

FIG. 22A and FIG. 22B illustrate an exemplary operation performed by the electronic device 100 to compose a message with context according to an embodiment of the disclosure. Referring to FIG. 22A, user 108 enters an input 2210 of “Waiting in Starbucks”. The modality feature extraction module 210 recognizes the input 2210 as text, the intent identification module 212 recognizes the intent as “Waiting”. The information module 214 recognizes the input 2210 as “waiting for scheduled meeting, meeting time: 4 pm and location: Starbucks.” The beautify module 216 predicts the layout template: Style: Cartoon, Font: Arial (Body), Size: 11, Text Color: Black; Foreground color: Yellow, and Background Color: Sky blue. The structural module 218 determines that no structure found. The modality prediction module 220 determines the mode of the multimodal content 112 to be an image and text mode and accordingly, the rendering module 222 generates a card template for the multimodal content 2220 as an output as shown in FIG. 22B.

FIG. 23A and FIG. 23B illustrate an exemplary operation performed by the electronic device according to an embodiment of the disclosure. Referring to FIG. 23A, the user 108 enters a voice input 2310 of “I am so hungry”. The modality feature extraction module 210 recognizes the input 2310 as voice, identifies pitch and creates annotated text. The intent identification module 212 recognizes the intent the user as “hunger-eat”. The information module 214 retrieves images tagged with a hunger from the database 208. The beautify module 216 predicts the layout template such as style, fonts, background as per image and an occasion. The structural module 218 determines that no structure found. The modality prediction module 220 determines the modes of the multimodal content 2320 to be an image and/or text mode and accordingly, the rendering module 222 generates various multimodal contents 2320 as an output as shown in FIG. 23B.

For another instance, the user 108 enters a text “Dear Parents, Please note that Sanskrit speaking and Vedic Maths class is cancelled for tomorrow on account of Akshay Tritya festival, however, there will be: Fun with Science: under 3 years olds 10-11 am=Simple science experiments. Dodge the tables: 7-13 year olds, 11 am-12 noon=revision of tables 2-12. No class for 4-6 years old tomorrow.” Looking forward to seeing you!”. The modality feature extraction module 210 recognizes the input as text, the intent identification module 212 recognizes the intent as “information”. The information module 214 retrieves the information such as when: tomorrow, keywords: Keywords: Sanskrit Speaking, Vedic Maths, Fun with science, Dodge the tables, Cancel due to Akshay tritya Festival, Simple science experiments, revision of tables 2-12, no class, Time: 10-11 am, 11-12 pm, Age: <3, 7-13, 4-6. The beautify module 216 predicts the layout template such as Style: Simple, Font: Time New Roman (Body), Size: 12, Text Color: Black. The structural module 218 determines the structure as Class: Sanskrit Speaking, Vedic Maths, Fun with science, Dodge the tables Time: 10-11 am, 11-12 pm; Age: <3, 7-13, 4-6 Details: Cancel due to Akshaytritya Festival, Simple science experiments, revision of tables 2-12, no class. The modality prediction module 220 determines the mode of the multimodal content 112 to be a text mode and accordingly, the rendering module 222 generates the multimodal content as an output, illustrated in the table below:

TABLE 1

| Tomorrow | | | |
|---|---|---|---|
| Class | Time | Age | Details |
| Sanskrit speaking | No | | Cancel due to Akshaytritya |
| | | | Festival |
| Vedic Maths | No | | Cancel due to Akshaytritya |
| | | | Festival |
| Fun with Science | 10-11 am | <3 | Simple science experiments |
| Dodge the tables | 11-12 pm | 7-13 | Revision of tables 2-12 |
| | | 4-6 | No class |

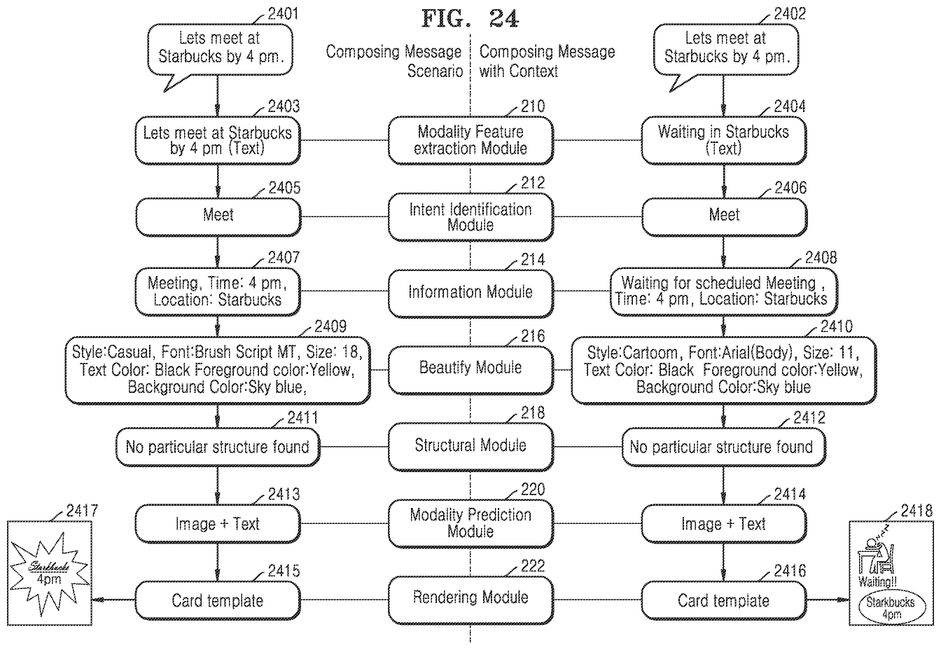

FIG. 24 illustrates a process of generating multimodal content as customized content according to an embodiment of the disclosure.

Referring to FIG. 24, steps 2401 through 2415 illustrate generating customized content 2417 by matching each of modules with corresponding function as illustrated in FIG. 21A and FIG. 21B.

Likewise, steps 2402 through 2416 illustrate generating customized content 2418 by matching each of modules with corresponding function as illustrated in FIG. 22A and FIG. 22B.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of generating a customized content, the method comprising:
obtaining an input from a user;
detecting, from the input, at least one feature and a modality of the input among a plurality of modalities comprising a text format, a sound format, a still image format, and a moving image format;
determining a mode of the customized content from a plurality of modes, based on the at least one feature and the modality of the input, the plurality of modes comprising an image mode and a text mode; and
generating the customized content based on the determined mode.

2. The method of claim 1, wherein the detecting the at least feature and the modality of the input comprises
detecting an emotion or an activity of the user based on texts recognized in the input; and
categorizing the modality and the at least one feature based on the detected emotion of the user or the detected activity of the user.

3. The method of claim 2, wherein the generating the customized content comprises generating the customized content based on the determined mode and the detected emotion of the user.

4. The method of claim 2, wherein the categorizing the modality and the at least one features comprises categorizing the modality and the at least one feature further based on a learned model and a predefined model.

5. The method of claim 1, further comprising:
obtaining intent information based on texts extracted from the input,
wherein the texts extracted from the input comprise at least one verb or one adjective, and
wherein the generating the customized content comprises generating the customized content based on the extracted texts and the determined mode.

6. The method of claim 5, further comprising:
determining at least one of a font size, a font type, or a color of the texts, based on the intent information; and
wherein the generating the customized content comprises generating the customized content based on the determined mode and the at least one of the font size, the font type, or the color of the texts.

7. The method of claim 1, further comprising
obtaining intent information based on texts extracted from the input, and
determining a layout of the customized content based on the intent information,
wherein the generating the customized content comprises generating the customized content based on the layout and the determined mode.

8. The method of claim 1, further comprising:
obtaining at least one of time information or location information from the input,
wherein the generating the customized content comprises generating the customized content based on the determined mode and the at least one of the time information or the location information.

9. The method of claim 1, further comprising:
determining that the customized content requires an intervention of the user; and
in response to the intervention of the user, displaying a second customized content.

10. The method of claim 1, wherein the input is a voice signal,
wherein the method further comprises:
converting the voice signal into texts;
identifying words, each of which has a pitch and a volume that are greater than a predetermined pitch and a predetermined volume, from the texts converted from the voice signal; and
determining text information based on the identified words,
wherein the generating the customized content comprises generating the customized content based on the text information and the determined mode.

11. The method of claim 1, further comprising:
obtaining intent information, which indicates an intention of the user, based on texts extracted from the input, wherein the input comprises a plurality of texts,
wherein the generating the customized content comprises generating the customized based on the intent information.

12. An apparatus for generating a customized content, the apparatus comprising:
at least one memory configured to store one or more instructions;
at least one processor configured to execute the one or more instructions to:
obtain an input from a user;
detect, from the input, at least one feature and modality of the input among a plurality of modalities comprising a text format, a sound format, a still image format, and a moving image format;
determine a mode of the customized content, from a plurality of modes, based on the at least one feature and the modality of the input, the plurality of modes comprising an image mode and a text mode; and
generate the customized content based on the determined mode, and a display configured to display the customized content.

13. The apparatus of claim 12, wherein the at least one processor is further configured to execute the one or more instructions to:
detect an emotion or an activity of the user based on texts recognized in the input; and
categorize the modality and the at least one feature based on the detected emotion of the user or the detected activity of the user.

14. The apparatus of claim 13, wherein the at least one processor is further configured to execute the one or more instructions to:
generate the customized content based on the determined mode and the detected emotion of the user.

15. The apparatus of claim 12, wherein the at least one processor is further configured to execute the one or more instructions to:
obtain intent information based on texts extracted from the input, the texts extracted from the input comprising at least one verb or one adjective, and
generate the customized content based on the extracted texts and the determined mode.

16. The apparatus of claim 15, wherein the at least one processor is further configured to execute the one or more instructions to:
determine at least one of a font size, a font type, or a color of the texts based on the intent information, and
generate the customized content based on the determined mode and the at least one of the font size, the font type, or the color of the texts.

17. The apparatus of claim 12, wherein the at least one processor is further configured to execute the one or more instructions to:
obtain intent information based on texts extracted from the input;
determine a layout of the customized content based on the intent information; and
generate the customized content based on the layout and the determined mode.

18. The apparatus of claim 12, wherein the at least one processor is further configured to execute the one or more instructions to:
obtain at least one of time information or location information from the input, and
generate the customized content based on the determined mode and the at least one of the time information or the location information.

19. The apparatus of claim 12, wherein the at least one processor is further configured to execute the one or more instructions to:
determine that the customized content requires an intervention of the user; and
in response to the intervention of the user, control the display to display a second customized content.

20. A non-transitory computer readable storage medium having a computer readable instructions stored therein, when executed by at least one processor, configured to execute the computer readable instructions to cause the at least one processor to:
obtain an input from a user;
detect, from the input, at least one feature and modality of the input among a plurality of modalities comprising a text format, a sound format, a still image format, and a moving image format;
determine a mode of a customized content, from a plurality of modes, based on the at least one feature and the modality of the input, the plurality of modes comprising an image mode and a text mode; and
generate the customized content based on the determined mode.
